(19) United States
(12) Patent Application Publication
(10) Pub. No.: US 2025/0331441 A1
(43) Pub. Date: Oct. 30, 2025

(54) DISPLAY FOR CONTROLLING ROBOTIC TOOL

(71) Applicant: Techtronic Cordless GP, Anderson, SC (US)

(72) Inventor: Chi Chau LEE, Hong Kong (CN)

(21) Appl. No.: 19/264,613

(22) Filed: Jul. 9, 2025

Related U.S. Application Data
(63) Continuation of application No. 18/353,576, filed on Jul. 17, 2023, now Pat. No. 12,369,509.
(60) Provisional application No. 63/390,574, filed on Jul. 19, 2022.

(51) Int. Cl. A01B 69/04; A01D 34/00; A01D 101/00

(52) U.S. Cl. CPC A01B 69/008; A01D 34/008; A01D 2101/00

(57) ABSTRACT

A device for use with a robotic garden tool, the device including a display, a device network interface configured to allow the external device to wirelessly communicate with the robotic tool, and an electronic processor coupled to the display, the device network interface, and a memory. The electronic processor is configured to retrieve a first position of the robotic garden tool when an add start point button is selected, the first position being indicative of a first start point remote of the dock.

### CROSS-REFERENCE OF RELATED APPLICATIONS

This application is a continuation application of U.S. application Ser. No. 18/353,576, filed on Jul. 17, 2023, which in turn is a formalization of U.S. Provisional Application No. 63/390,574, filed on Jul. 19, 2022. The contents of both applications are hereby incorporated by reference.

### FIELD

The embodiments described herein related to a robotic tools, particularly to displays for controlling and monitoring start points of a robotic garden tool.

### BACKGROUND

Robotic tools typically have some form of controller or control unit associated therewith to control the movement and operation of the robotic tool during use.

### SUMMARY

In one aspect, an external device for use with one or more robotic tools, the external device including a display, a device network interface configured to allow the external device to wirelessly communicate with the one or more robotic tools, an electronic processor coupled to the display, the device network interface, and a memory, and configured to communicate with the one or more robotic garden tools via the device network interface, the electronic processor configured to display a start point screen on the display, the start point screen including an initiate setup button and an add start point button, where when the initiate setup button is selected by a first user input, the processor is configured to send a signal to the first robotic garden tool to travel from a dock and along a perimeter of an operating area, where the first robotic garden tool includes an odometry unit, which, while the first robotic garden tool travels along the boundary of the operating area, gathers data indicative of the position of the first robotic garden tool, where when the add start point button is selected by a second user input, the processor is configured to retrieve a first position of the first robotic garden tool, the first position being indicative of a first start point remote of the dock, and where the first robotic garden tool is configured to return to the dock after traveling along the perimeter and to communicate a calculated boundary length based on the data gathered by the odometry unit to the processor.

Alternatively or additionally, in any combination, where the start point button is configured to be selected during a first instance of the first robotic garden tool traveling from the dock and along the boundary of the operating area.

Alternatively or additionally, in any combination, where the odometry unit continuously communicates data indicative of the position of the first robotic garden tool with the external device via the device network interface.

Alternatively or additionally, in any combination, where a current boundary length is calculated based on the data gathered by the odometry unit, and the current boundary length is displayed on the setup screen as the first robotic garden tool travels along the boundary.

Alternatively or additionally, in any combination, where the setup screen includes an indicia relating to the calculated perimeter length.

Alternatively or additionally, in any combination, where the setup screen includes a line segment indicative of the perimeter, and a first start point indicia is populated adjacent the line segment at a corresponding length along the boundary as the first position.

Alternatively or additionally, in any combination, where the setup screen further includes a start point indicia relating to the length of the first position relative to the dock.

Alternatively or additionally, in any combination, where in a first lap of the first robotic garden tool along the perimeter, the odometry unit gathers data for calculation of the boundary length, and in a subsequent start point setting lap of the first robotic garden tool along the perimeter, the start point button is selected by the second user input to generate the first start point.

Alternatively or additionally, in any combination, after the first robotic garden tool returns to the dock and receives instructions to operate in a general operational state, the first robotic garden tool is configured to travel along the perimeter to the first start point and operate within the operating area starting from the first start point.

Alternatively or additionally, in any combination, where when the add start point button is selected by a third user input, the processor is configured to retrieve a second position of the first robotic garden tool, the second position being indicative of a second start point remote of the dock, the second position being different than the first position, and one of the first robotic garden tool and the external device includes a frequency balancing feature configured to determine whether the first robotic garden tool should travel along the perimeter to the first start point or the second start point prior to operation within the operating area from either the first start point or the second start point.

In another aspect, an external device including a display, a device network interface configured to allow the external device to wirelessly communicate with one or more robotic garden tools, an electronic processor coupled to the display, the device network interface, and the memory, and configured to communicate with the one or more robotic garden tools via the device network interface, the electronic processor configured to display a start point screen on the display, the start point screen including a line segment indicative of a perimeter of an operating area, and at least one start point indicator indicative of a first start point of the first robotic tool along the boundary, where when a first start point indicator of the at least one start point indicator is selected by a first user input, the processor is configured to send a signal to the first robotic garden tool to travel to the first start point, and where the first start point indicator is configured to be edited by a second user input to edit the first start point, and the processor is configured to reprogram the first start point to an adjusted first start point.

Alternatively or additionally, in any combination, where the first start point indicator is positioned adjacent the line segment a corresponding amount relating to a first distance between a dock on the perimeter and the first start point.

Alternatively or additionally, in any combination, where the edited first start point is positioned adjacent the line segment a corresponding amount relating to a second distance between the dock and the edited start point.

Alternatively or additionally, in any combination, where the electronic processor is configured to display a start point indicia on the start point screen and adjacent both the first start point indicator and the line segment, the start point indicia providing further indication of the distance between the dock and the first start point.

Alternatively or additionally, in any combination, where the electronic processor is configured to display a second start point indicator on the start point screen, the second start point indicator being indicative of a second start point of the first robotic garden tool along the boundary.

Alternatively or additionally, in any combination, where the electronic processor is configured to display a boundary length indicia on the start point screen, the boundary length indicia being indicative of a length of the boundary.

Alternatively or additionally, in any combination, where the electronic processor is configured to display a graphical user input interface once the external device receives the second user input, the graphical user input interface presenting to a user a plurality of options for adjusting the position of the first start point to the adjusted first start point.

In another aspect, an external device including a display, a device network interface configured to allow the external device to wirelessly communicate with one or more robotic garden tools, an electronic processor coupled to the display, the device network interface, and the memory, and configured to communicate with the one or more robotic garden tools via the device network interface, the electronic processor configured to display a start point screen on the display, the start point screen including a first display area having a line segment and at least one frequency adjustment indicator, where the line segment is indicative of a starting frequency of a first robotic garden tool of the one or more robotic garden tools to start cutting at either a first start point or a second start point different than the first start point, and where the frequency adjustment indicator is configured to be edited by a user input to edit the starting frequency of the first robotic garden tool.

Alternatively or additionally, in any combination, where the electronic processor is further configured to display a second display area having a second line segment and at least one start point indicator.

Alternatively or additionally, in any combination, where the first line segment and the second line segment extend parallel to one another in the first display area and the second display area, respectively.

In another aspect, an external device for use with a robotic garden tool, the external device including a display, a device network interface configured to allow the external device to wirelessly communicate with the robotic tool, an electronic processor coupled to the display, the device network interface, and a memory, and configured to communicate with the robotic garden tool via the device network interface, the electronic processor configured to display a start point screen on the display, the start point screen including an initiate setup button and an add start point button, where when the initiate setup button is selected by a first user input, the processor is configured to send a signal to the robotic garden tool to travel from a dock and along a perimeter of an operating area, and where when the add start point button is selected by a second user input, the processor is configured to retrieve a first position of the robotic garden tool, the first position being indicative of a first start point remote of the dock.

Alternatively or additionally, in any combination, where the add start point button is configured to be selected during a first instance of the robotic garden tool traveling from the dock and along the boundary of the operating area.

Alternatively or additionally, in any combination, where the robotic garden tool includes a location tracking device which gathers data indicative of the position of the robotic garden tool, and where the location tracking device continuously communicates data indicative of the position of the robotic garden tool with the external device via the device network interface.

Alternatively or additionally, in any combination, where a current boundary length is calculated based on the data gathered by the location tracking device, and the current boundary length is displayed on the setup screen as the first robotic garden tool travels along the boundary.

Alternatively or additionally, in any combination, where the setup screen includes an indicia relating to a calculated perimeter length.

Alternatively or additionally, in any combination, where the setup screen includes a line segment indicative of the perimeter, and a first start point indicia is populated adjacent the line segment at a corresponding length along the boundary as the first position.

Alternatively or additionally, in any combination, where the setup screen further includes a start point indicia relating to the length of the first position relative to the dock.

Alternatively or additionally, in any combination, where in a first lap of the first robotic garden tool along the perimeter, the electronic processor gathers data for calculation of the boundary length, and in a subsequent start point setting lap of the robotic garden tool along the perimeter, the start point button is selected by the second user input to generate the first start point.

Alternatively or additionally, in any combination, where after the robotic garden tool returns to the dock and receives instructions to operate in a general operational state, the robotic garden tool is configured to travel along the perimeter to the first start point and operate within the operating area starting from the first start point.

Alternatively or additionally, in any combination, where when the add start point button is selected by a third user input, the processor is configured to retrieve a second position of the robotic garden tool, the second position being indicative of a second start point remote of the dock, the second position being different than the first position.

In another aspect, a device for use with a robotic garden tool, the external device including a user interface, a device network interface configured to allow the external device to wirelessly communicate with the robotic tool, an electronic processor coupled to the display, the device network interface, and a memory, and configured to communicate with the robotic garden tool via the device network interface, the electronic processor configured to change into a validation state upon receiving a first user input, display a first start point indicator representative of a corresponding first start point saved in memory, where when the start point indicator is selected by the user when the electronic processor is in the validation state, the processor is configured to send a signal to the robotic garden tool to travel to and stop at the first start point.

Alternatively or additionally, in any combination, where the first start point is positioned remote of a docking station.

Alternatively or additionally, in any combination, where the user interface includes a line segment, and where the first start point indicator is populated adjacent the line segment.

Alternatively or additionally, in any combination, where when the user moves the start point indicator along the line segment while the electronic processor is in the validation state after the robotic garden tool has stopped at the first start point, the electronic process is configured to send a signal to the robotic garden tool to travel along the perimeter of a working area.

Alternatively or additionally, in any combination, where the robotic garden tool physically travels a distance and direction along the perimeter corresponding to the distance and direction the start point indicator is moved along the line segment.

Alternatively or additionally, in any combination, where the electronic processor is configured to display a second start point indicator representative of a second start point saved in memory, where when the second start point indicator is selected by the user when the electronic processor is in the validation state, the processor is configured to send a signal to the robotic garden tool to travel to and stop at the second start point.

In another aspect, a method of operating a robotic garden tool in a working area and remote of a dock, the method including recording a first start point and a second start point in a setup state, at least one of the first start point and the second start point being remote of the dock, actuating a drive mechanism to move the robotic garden tool to the first start point, after reaching the first start point, operating the robotic garden tool using a first operational parameter to enter the working area, actuating the drive mechanism to move the robotic garden tool to the second start point, after reaching the second start point, operating the robotic garden tool using a second operational parameter to enter the working area, where the second operational parameter is different than the first operational parameter.

Alternatively or additionally, in any combination, where at least one of the first operational parameter and the second operational parameter is selected from the group consisting of departure angle, turn angle, cutting pattern, travel path, cutting height, cutting speed, and travel speed.

Alternatively or additionally, in any combination, where at least one of the first operational parameter and the second operational parameter is selected at random.

Alternatively or additionally, in any combination, where at least one of the first operational parameter and the second operational parameter may be changed.

### BRIEF DESCRIPTION OF THE DRAWINGS

FIG. 1A illustrates a communication system including a robotic tool according to some example embodiments.

FIG. 1B illustrates a bottom perspective view of the robotic tool of FIG. 1A according to some example embodiments.

FIG. 2 is a block diagram of the robotic tool of FIGS. 1A and 1B according to some example embodiments.

FIG. 3 is a block diagram of the external device of FIG. 1A according to some example embodiments.

FIG. 4 is a perspective view of an odometry sensor and a motor-driven wheel of the robotic tool of FIG. 1A.

FIGS. 5A-5B are top views of the robotic garden tool of FIG. 1A traveling along an exemplary operating area.

FIGS. 6A-6B are top views of the robotic garden tool of FIG. 1A operating in the exemplary operating area.

FIGS. 7A-7E illustrate the robotic tool of FIG. 1A operating in an exemplary operating area and an initialization setup screen displayed on the external device.

FIG. 7F illustrates screenshots of an example a start point screen including a validation mode enabling icon.

FIG. 8 illustrates a screenshot of an example boundary screen/graphical user interface that may be displayed on a second display of the external device of FIG. 1A according to some embodiments.

FIGS. 9A-9E illustrate screenshots of exemplary start point screens/graphical user interfaces that may be displayed on the second display of the external device of FIG. 1A according to some example embodiments.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect.

It should be noted that a plurality of hardware and software based devices, as well as a plurality of different structural components may be utilized to implement the invention. Furthermore, and as described in subsequent paragraphs, the specific configurations illustrated in the drawings are intended to exemplify embodiments of the invention and that other alternative configurations are possible. The terms “processor,” “central processing unit,” and “CPU” are interchangeable unless otherwise stated. Where the terms “processor” or “central processing unit” or “CPU” are used as identifying a unit performing specific functions, it should be understood that, unless otherwise stated, those functions can be carried out by a single processor, or multiple processors arranged in any form, including parallel processors, serial processors, tandem processors or cloud processing/cloud computing configurations.

Throughout this application, the term “approximately” may be used to describe the dimensions of various components and/or paths of travel of a robotic garden tool. In some situations, the term “approximately” means that the described dimension is within 1% of the stated value, within 5% of the stated value, within 10% of the stated value, or the like. When the term “and/or” is used in this application, it is intended to include any combination of the listed components. For example, if a component includes A and/or B, the component may include solely A, solely B, or A and B.

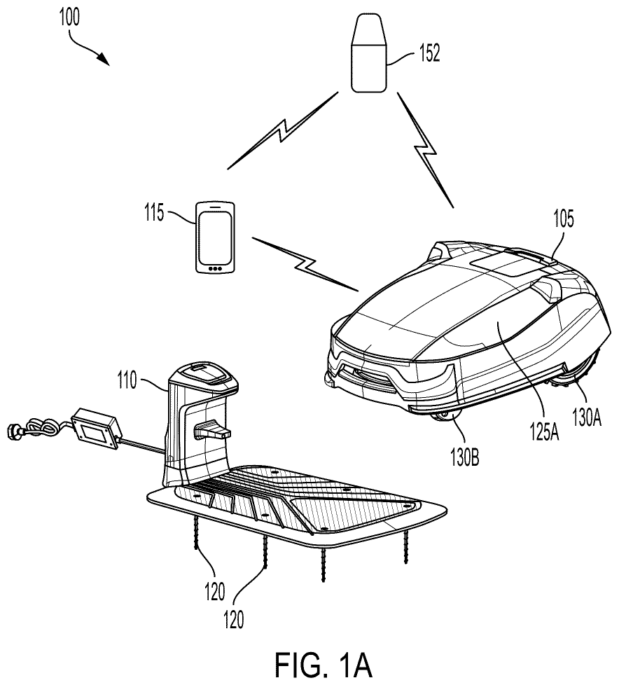

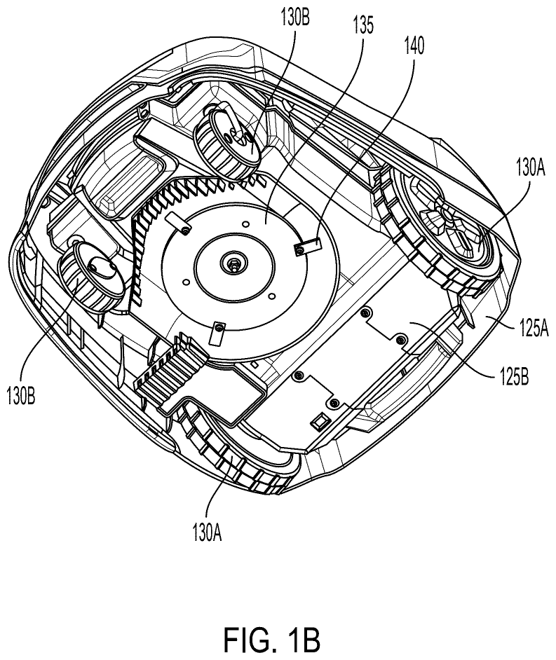

FIG. 1A illustrates a communication system 100 that may include a robotic tool 105 (e.g., a robotic lawn mower), a docking station 110 for use with the robotic tool 105, an external device 115, and a server 152 according to some example embodiments. The robotic tool 105 may include a tool for cutting debris, sweeping debris, vacuuming debris, clearing debris, collecting debris, moving debris, and the like. Debris, in turn, may include plants (such as grass, leaves, flowers, stems, weeds, twigs, branches, etc., and clippings thereof), dust, dirt, jobsite debris, snow, and/or the like. For example, other implementations of the robotic tool 105 may include a vacuum cleaner, a trimmer, a string trimmer, a hedge trimmer, a sweeper, a cutter, a plow, a blower, a snow blower, etc.

In some embodiments, a lawn may include any type of property that includes grass, a crop, some other material to be trimmed, cleared, gathered, etc., and/or that includes some material to receive treatment from the robotic tool 105 (e.g., fertilizer to treat grass in the lawn). In some embodiments, a lawn may include paved portions of a property (e.g., a driveway), for example, when the robotic tool 105 is used for snow plowing/removal.

The docking station 110 of the system 100 is generally positioned along the perimeter 610 of the operating area 605 and is configured to serve as a docking location for the tool 105. More specifically, during use the robotic tool 105 may be configured to dock at the docking station 110 in order to charge a battery 245 and/or exchange information therebetween. In some embodiments, the docking station 110 is also configured to make an electrical connection with a power supply (e.g., via a cord and plug connected to a wall outlet that is connected to a power grid) in order to provide charging current to the robotic tool 105 when the robotic tool 105 is electrically coupled with the docking station 110. The docking station 110 may also include a hardline, wireless, and/or co-axial cable connection to allow data to transmitted thereto in both a wired and wireless fashion.

In some embodiments, the docking station 110 may also be electrically connected to a boundary wire 608 extending along and at least partially establishing the perimeter 610 of an operating area 605. In the illustrated embodiment, the boundary wire 608 generally runs along and is aligned with the perimeter 610. However, in some other embodiments, the boundary wire 608 may be offset (in an inward or outward direction) relative to the perimeter 610. In some embodiments, the docking station 110 provides power to the boundary wire 608 whereby the boundary wire 608 emits, for example, an electromagnetic signal that may be detected by the robotic tool 105.

In some embodiments, the robotic tool 105 does not operate in conjunction with a boundary wire 608. Rather, the robotic tool 105 may include mapping capabilities, position tracking capabilities (e.g., via GPS, odometry, and/or the like) that allow the robotic tool 105 to remain within the predefined perimeter 610 without the use of a physical boundary wire 608.

While FIG. 1A illustrates one robotic tool 105, one docking station 110, and one external device 115, in some embodiments, the communication system 100 includes additional robotic tools 105, docking stations 110, and/or external devices 115. In some embodiments, a single external device 115 may be configured to communicate with multiple robotic tools 105 to control and/or monitor the multiple robotic tools 105. In some embodiments, a single one of the robotic tools 105 may be configured to dock to a plurality of docking stations 110. Still further, in embodiments where more than one robotic tool 105 is present, different types of tool 105 may be used. For example, the system 100 may include a lawn mower, a string trimmer, and a fertilizer.

While FIG. 1A illustrates one server 152, in some embodiments, the communication system 100 may include additional servers 152. In still other embodiments, the communication system 100 may not include any servers 152. While not shown in FIG. 1A, as mentioned above, in some embodiments the communication system 100 may include a network such as a cellular network that includes one or more devices that act as an intermediary device to allow the robotic tool 105 to bidirectionally communicate with the external device 115 when the robotic tool 105 and the external device 115 are not within direct communication range of each other.

If the communication system 100 becomes disconnected for any reason during which the robotic tool 105 requires wireless communication, at least one of the first electronic processor 205 and the second electronic processor 305 may determine that the communication system 100 is disconnected via a signal or a lack of signal received by either the first network interface 215 or the second network interface 315. In the event that communication system 100 is disconnected, operation of the robotic tool 105 may cease, and/or the robotic tool 105 may return to the docking station 110. Subsequently, the second electronic processor 305 may display via the second display 325 to the user that the communication system 100 is disconnected. The user may be prompted via the second display 325 to reconnect the communication system 100 prior to further operation of the robotic tool 105. This may require, in the instance of Bluetooth™ and/or WiFi™ communications, for the user to physically locate the external device 115 closer to the robotic tool 105 and/or vice versa.

FIG. 1B illustrates a bottom perspective view of the robotic tool 105 according to some example embodiments. The robotic tool 105 may include a housing 125 that may include an outer housing 125A (i.e., outer housing shell) and an inner housing 125B. The outer housing 125A may be coupled to the inner housing 125B. The robotic tool 105 also may include wheels 130 (i.e., a set of wheels 130) coupled to the inner housing 125B and configured to rotate with respect to the housing 125 to propel the robotic tool 105 on an operating surface (e.g., a yard to be mowed). The wheels 130 may include motor-driven wheels 130A and non-motor-driven wheels 130B. In the embodiment shown in FIG. 1B, two rear motor-driven wheels 130A are motor-driven wheels 130A while two front wheels 130B are non-motor-driven wheels 130B. In other embodiments, the robotic tool 105 may include a different wheel arrangement (e.g., a different number of total wheels, a different number of each type of wheel, different wheels being motor-driven or non-motor-driven, and/or the like). In some embodiments, the housing 125 may not include the outer housing 125A and the inner housing 125B. Rather, the housing 125 may include a single integrated body/housing to which the wheels 130 are attached.

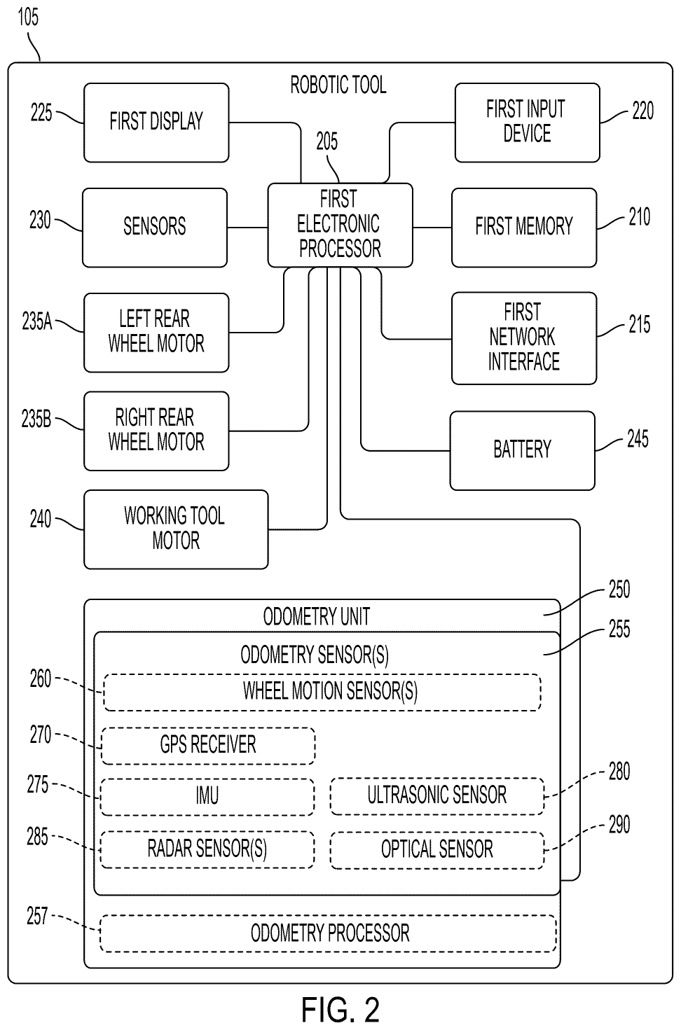

The robotic tool 105 also includes a wheel motor 235 (see FIG. 2) coupled to one or more wheels 130 and configured to drive rotation of the one or more wheels 130. In the illustrated embodiment, the robotic tool 105 includes multiple wheel motors 235 where each wheel motor 235 is configured to drive rotation of a respective motor-driven wheel 130A (see FIG. 2).

The robotic tool 105 also includes a working tool 135 configured to treat or otherwise interact with an operating area 605 within which the robotic tool 105 travels. The working tool 135 may be any working tool configured to interact with the operating area 605. For example, the working tool 135 in the illustrated embodiment is a cutting blade assembly which is coupled to the inner housing 125B and configured to rotate with respect to the housing 125 to cut grass within the operating area 605. In the illustrated embodiment, the working tool 135 may include a rotating disc to which a plurality of cutting blades 140 configured to cut the grass are attached. In some embodiments, the robotic tool 105 includes a working tool motor 240 (see FIG. 2) coupled to the inner housing 125B and to the working tool 135. The working tool motor 240 may be configured to drive rotation of the working tool 135. Other embodiments of the robotic tool 105 may include correspondingly operating working tools 135. For example, in embodiments where the robotic tool 105 is a plow, the working tool 135 thereof may include a fixed or articulating plow configured to plow snow or other debris or plow underlying dirt of the operating area 605. In embodiments where the robotic tool 105 spreads fertilizer, the working tool 135 may include a fertilizer spreader and feed system. Various other embodiments are envisioned.

In some embodiments, the robotic tool 105 and/or the docking station 110 include additional components and functionality than is shown and described herein.

FIG. 2 is a block diagram of the robotic tool 105 according to some example embodiments. In the embodiment illustrated, the robotic tool 105 includes a first electronic processor 205 (for example, a microprocessor or other electronic device). The first electronic processor 205 includes input and output interfaces (not shown) and is electrically coupled to a first memory 210, a first network interface 215, an optional first input device 220, an optional display 225, one or more sensors 230, a left rear wheel motor 235A, a right rear wheel motor 235B, a working tool motor 240, and a battery 245.

In some embodiments, the robotic tool 105 includes fewer or additional components in configurations different from that illustrated in FIG. 2. For example, the robotic tool 105 may include a location tracking device (e.g., a global positioning system (GPS) receiver) and/or a height adjustment motor configured to adjust a height of the working tool 135 (e.g., to set the cutting height). As yet another example, the robotic tool 105 may include additional sensors or fewer sensors than the sensors 230 described herein. In some embodiments, the robotic tool 105 performs functionality other than the functionality described below.

The first memory 210 of the tool 105 may include read only memory (ROM), random access memory (RAM), other non-transitory computer-readable media, or a combination thereof. The first electronic processor 205 is configured to receive instructions and data from the first memory 210 and execute, among other things, the instructions. In particular, the first electronic processor 205 executes instructions stored in the first memory 210 to perform the methods described herein.

The first network interface 215 of the tool 105 is configured to send data to and receive data from other devices in the communication system 100 (e.g., the external device 115, the server 152, etc.). In some embodiments, the first network interface 215 includes one or more transceivers for wirelessly communicating with the external device 115 and/or the docking station 110 (e.g., a first radio frequency (RF) transceiver configured to communicate via Bluetooth™, WiFi™, or the like). The first network interface 215 may include an additional transceiver for wirelessly communicating with the server 152 via, for example, cellular communication. In some embodiments, at least some of the transceivers and/or receivers of the robotic tool 105 may be combined or share some elements (e.g., an antenna and/or other hardware). Alternatively or additionally, the first network interface 215 may include a connector or port for receiving a wired connection to the external device 115, such as USB cable.

As indicated in FIG. 1A, the robotic tool 105 is configured to bidirectionally wirelessly communicate with the external device 115 and/or the server 152. In some embodiments, the robotic tool 105 is configured to directly communicate with the external device 115 when the robotic tool 105 is within communication range of the external device 115 (e.g., via Bluetooth™, WiFi™, or the like). The robotic tool 105 is additionally or alternatively configured to communicate with the external device 115 via an intermediary device such as the server 152, a cellular communication tower/base station, another device in a cellular network, or the like (e.g., when the robotic tool 105 is outside of direct communication range with the external device 115). In some embodiments, other intermediate devices may provide a communication link between the external device 115 and the robotic tool 105. For example, the docking station 110 may function as an intermediate device providing a communication link between the external device 115 and the robotic tool 105. In some embodiments, the docking station 110 may serve as a range extender device (e.g., a “hot spot”) configured to extend a communication range of any given communication protocol (e.g., Bluetooth™, WiFi™, or the like) between any of the external device 115, the robotic tool 105, and the server 152.

The first user input device 220 of the tool 105 is configured to allow the first electronic processor 205 to receive a user input to, for example, set/adjust an operational parameter (i.e., an attribute) (e.g., cutting/shoveling height, a blade speed, volumetric flow rate of fertilizer, travel path of the mower) of the robotic tool 105.

The first display 225 of the tool 105 is configured to display a user interface to the user (e.g., current power levels, current operating conditions, the presence of any alerts or faults, network status, described below). Similar to the user interface of the external device 115 (described below), the user interface displayed on the first display 225 may allow the user to access and interact with robotic mower information.

In some embodiments, the first display 225 may also act as the first input device 220. For example, a touch sensitive input interface (e.g., a touchscreen) may be incorporated into the first display 225 to allow the user to interact with content provided on the first display 225. The first display 225 may be a liquid crystal display (LCD) screen, an organic light emitting display (OLED) display screen, or an E-ink display. In some embodiments, the first display 225 includes future-developed display technologies.

In the illustrated embodiment, the first electronic processor 205 is in communication with a plurality of sensors 230 associated with the tool 105. Such sensors 230 may include electromagnetic field sensors, radio frequency sensors (e.g., radio frequency identification (RFID) interrogators/sensors), Hall sensors, other magnetic sensors, a transceiver/receiver of the first network interface 215, and/or the like. In some embodiments, the inner housing 125B includes at least two boundary cable sensors 230 in the form of electromagnetic field sensors configured to detect an electromagnetic signal being emitted by the boundary wire 608. For example, the electromagnetic field sensors may be able to detect a strength and/or a polarity of the electromagnetic signal from the boundary wire 608.

As shown in FIG. 2, the robotic tool 105 may also include an odometry unit 250. The odometry unit 250 is in operable communication with the first electric processor 205 and is configured to monitor and track the trajectory of the robotic tool 105 during operation. More specifically, the odometry unit 250 includes one or more odometry sensors 255 configured to collect data regarding the operation of (e.g., the position of) the robotic tool 105 and output the collected data to be processed by a processor (e.g., the first electronic processor 205, the second electronic processor 305, a processor of the docking station 110, and/or a processor of the server 152) to calculate the trajectory traveled by the mower 105.

In some embodiments, the odometry unit 250 may be a stand-alone device having a dedicated odometry processor 257 to independently process the data output by the one or more odometry sensors 255. The odometry processor 257, in turn, may be in two-way communication with the first electronic processor 205 of the robotic tool 105. The odometry unit 250 may output, via the odometry processor 257, a compiled (e.g., calculated) trajectory to the first electronic processor 205. However in other embodiments, raw data may be sent from the odometry sensor(s) 255 to any one of the first electronic processor 205, the second electronic processor 305, and/or the cloud where the data from the odometry sensor(s) 255 may be processed to calculate a trajectory of the robotic tool 105. The first electronic processor 205 of the robotic tool 105 may also transmit the data from the odometry unit 250 (raw or processed) via the first network interface 215 and the second network interface 315 to the second electronic processor 305 of the external device 115.

In one embodiment, the odometry unit 250 may include one or more wheel motion sensors 260, each coupled to and in operable communication with a corresponding motor-driven wheel 130A. More specifically, each wheel motion sensor 260 may be configured to detect and output a signal representative of how far and in what direction the corresponding motor-driven wheel 130A has rotated.

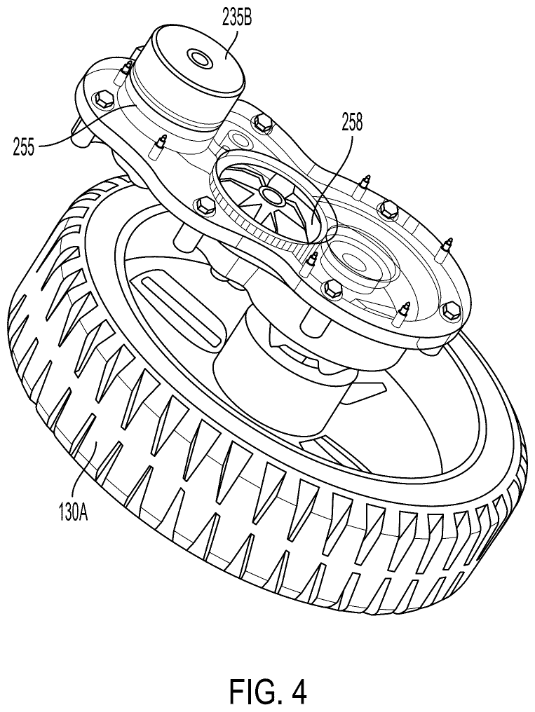

In some embodiments, the wheel motion sensor 260 may gather data indicative of when and how often the corresponding motor-driven wheel 130A is rotated. Measurement of each motor-driven wheel 130A may be taken directly (e.g., with a Hall effect magnet positioned on the motor-driven wheel 130A itself) or indirectly (e.g., with a Hall effect magnet or other magnetic component positioned on the wheel motors 235A, 235B). FIG. 4 illustrates an exemplary motor-driven wheel 130A. In the illustrated embodiment of FIG. 4, the odometry sensor 255 is positioned adjacent the wheel motor 235A upstream of a gear train 258 which couples the wheel motor 235B to the motor-driven wheel 130A. The odometry sensor 255 may also be configured to sense rotation of any component (e.g., a gear) of the gear train 258 and/or the motor-driven wheel 130A itself. Data from the odometry sensor 255 may be scaled according to gear ratios between the wheel motor 235A, the gear train 258, and the motor-driven wheel 130A to properly determine rotation of the motor-driven wheel 130A.

In some embodiments, the wheel motion sensor(s) 260 may be or include another type (or types) of sensors configured to gather data indicative of motion of the tool 105. For example, the wheel motion sensor(s) 260 may be laser or other types of tachometers. Such tachometer wheel motion sensor(s) may shine a light source (e.g., a LED light, laser beam or the like) against a tachometer surface of one of the motor-driven wheels 130A and/or the non-motor-driven wheels 130B, or any component of any gear train coupled thereto (e.g., the gear train 258), the light source may be reflected by the tachometer surface, and the tachometer may receive a signal indicating receipt of the light source. The tachometer may then determine a time difference in the amount of time for the light to be emitted and received, the time difference being indicative of how fast the motor-driven wheels 130A and/or the non-motor-driven wheels 130B is rotating.

During operation, the wheel motion sensor 260 tracks motion of the robotic tool 105 over time and outputs raw data regarding the detected motion to a processor (e.g., the first electronic processor 205, the second electronic processor 305, and/or the odometry processor 257). The processor, in turn, may then continuously or periodically determine an amount and direction of rotation for any given wheel 130 of the robotic tool 105. For example, one wheel motion sensor 260 may monitor the rotation of a left-side motor-driven wheel 130A, and another wheel motion sensor 260 may monitor the rotation of a right-side motor-driven wheel 130A. One exemplary wheel motion sensor 260 may detect angular rotation of (e.g., full rotations and/or partial rotations) of at least one of the wheels 130. With a fixed and known wheel size, and a sensed angular rotation of the wheel 130 with the wheel motion sensor 260, the electronic processor 205 can calculate the arc length of the wheel 130 (e.g., distance traveled over the support surface 50). In some embodiments, the wheel motion sensors 260 may be configured to intermittently and simultaneously gather data indicative of the position of the corresponding motor-driven wheel 130A. Data may be gathered by the wheel motion sensor 260 at any desired frequency (e.g., 100 Hz, 10 kHz, 1 MHZ, etc.) according to the desired accuracy. The data may be collocated along with a timer and/or real-time clock.

In some embodiments, the odometry unit 250 includes an inertial measurement unit (IMU) 275. The IMU 275 gathers data indicative of the rotational orientation of the mower body (e.g., roll, pitch, yaw). The IMU 275 may include or entirely comprise, for example, an accelerometer, a magnetometer, a gyroscope, and the like. The IMU 275 may have a similar data collection frequency (e.g., 100 Hz, 10 kHz, 1 MHz, etc.) when compared to the wheel motion sensor 260 and/or other sensors of the odometry unit 250. The IMU 275 is configured to output a signal (or a plurality of signals, e.g., a first signal representing roll, a second signal representing pitch, a third signal representing yaw) representative of the rotational orientation of the robotic tool 105.

In some embodiments, the odometry unit 250 may include a radar sensor (e.g., a mmWave Radar sensor) 285. The radar sensor 285 may be configured to measure relative speed between the robotic tool 105 and an object in the environment of the robotic tool (e.g., the grass, ground, and/or soil of the operating area 605, a tree, a building, etc.). The radar sensor 285 is configured to output a signal (or a plurality of signals) representative of the speed of the robotic tool 105 relative to the object in the environment.

In some embodiments, the odometry unit 250 may include a global positioning system (GPS) receiver 270 configured to gather data indicative of the position thereof relative to a remote satellite. In other embodiments, the odometry unit 50 may include other types of sensors such as ultrasonic sensors 280, optical sensors 290 (e.g., laser sensors, infrared sensors), and/or the like. Such sensors may gather data indicative of the position of the robotic tool 105, and be configured to export the data for use by the odometry unit 250 to determine the position and orientation of the robotic tool 105 during use.

In still some embodiments, the odometry unit 250 may include any combination of the above-described odometry sensors 255 (e.g., the wheel motion sensor 260, the GPS Receiver 270, the IMU 275, the ultrasonic sensor 280, the radar sensor 285, and the optical sensor 290). The odometry unit 250 may be configured to receive and combine a plurality of inputs from any combination of the above-described odometry sensors 255. For example, the odometry unit 250 may include a wheel motion sensor 260, and an inertial measurement unit (i.e., IMU) 275. Data from wheel motion sensor (or sensors) 260 may be combined by the odometry unit 250 or by either the first electronic processor 205 or the second electronic processor 305 with data from the inertial measurement unit to generate a more accurate representation of the position of the robotic tool 105. This combination of data may account for, for example, sloped terrain including changes in elevation in an operating area 605 of the robotic tool 105. The combination of the data from the wheel motion sensor (or sensors) 260 and data from the inertial measurement unit 275 may otherwise add accuracy to the position of the robotic tool 105.

In still other embodiments, the odometry unit 250 may include a wheel motion sensor (or sensors) 260, and a radar (e.g., a mmWave) sensor 285. Data from the wheel motion sensor (or sensors) 260 may be combined by the odometry unit 250 or by either the first electronic processor 205 or the second electronic processor 305 with data from the radar sensor 285 to generate a more accurate representation of the position of the robotic tool 105. This combination of data may account for, for example, instances in which one or more of the motor-driven wheels 130A are rotated, but the robotic tool 105 does not in fact move in the operating area 605. This phenomenon may be described as “wheel slip” or “wheel slippage” of one or more of the motor-driven wheels 130A relative to the environment (e.g., the grass, ground, and/or soil of the operating area 605, a tree, a building, etc.).

In still other embodiments, the odometry unit 250 may include a wheel motion sensor (or sensors) 260, an inertial measurement unit 275, and a radar (e.g., a mmWave) sensor 285. Data from the wheel effect sensor (or sensors) 260 may be combined by the odometry unit 250, the first electronic processor 205, or the second electronic processor 305 with both data from the inertial measurement unit 275 and data from the radar sensor 285 to generate a more accurate representation of the position of the robotic tool 105. This combination of data may account for, for example, both sloped terrain including changes in elevation in the operating area 605 as well as any slipping motor-driven wheels 130A.

The robotic tool 105 also includes a timer and/or a real-time clock that may be implemented by the first electronic processor 205. The timer and/or real-time clock may be used in conjunction with the odometry unit 250 to collocate data gathered by at least one odometry sensor 255 and ultimately to determine a distance that the robotic tool 105 has traveled from any given start point 615 and/or the docking station 110. In some embodiments, the robotic tool 105 further comprises an uninterruptible power source, such as a button cell battery or battery pack, which may be charged by either the docking station 110 and/or the battery 245. The uninterruptible power source may provide power to the timer and/or the real-time clock to ensure accuracy of the timer and/or real-time clock in the event that the battery 245 is depleted. The first electronic processor 205 may use stored scheduling information and/or retrieved scheduling information to control times at which the robotic tool 105 is configured to operate, dock, etc. Such scheduling information may be stored in the first memory 210, the second memory 310, and/or the memory of the server 152.

Once a first set of data points regarding the movement of the tool 105 are gathered (e.g., corresponding to a given time), the corresponding data can be saved in any memory (e.g., by a memory of the odometry unit 250 (not shown), the first memory 210, the second memory 310, and/or a memory of the docking station 110 or the server 152) for future use. Once a second set of data points are gathered (e.g., corresponding to a later time), the second set of data points are compared (e.g., by the odometry processor 257 or the first electronic processor 205) to the second set of data points. In this comparison, for example, the odometry unit 250 may determine whether the left side motor-driven wheel 130A was rotated forwards an amount greater than the right side motor-driven wheel 130A. This is indicative of a right-hand turn of the robotic tool 105 as the robotic tool 105 is driven forwards. Other corresponding comparisons may be made for left-hand turns, straight travel, reverse travel, as well as left-handed and right-handed turning reverse travel. Further sets of data points are gathered at the desired data collection frequency (e.g., 100 Hz, 10 kHz, 1 MHz, etc.) to continuously monitor the position of the robotic tool 105. Data generated by the odometry unit 250 need not continuously be saved to memory. In some embodiments, only portions of data may be saved, and/or data may be saved and then subsequently erased (e.g., in a first in-first out basis, when it is no longer needed, or the like) to avoid requiring large amounts of memory.

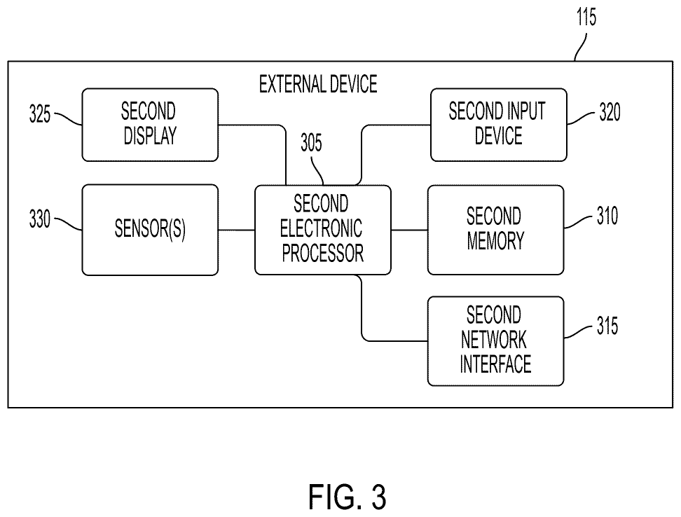

FIG. 3 is a block diagram of the external device 115 according to some example embodiments. In the example shown, the external device 115 includes a second electronic processor 305 electrically connected to a second memory 310, a second network interface 315 (i.e., device network interface 315), a second user input device 320, and a second display 325. These components are similar to the like-named components of the robotic tool 105 explained above with respect to FIG. 2 and function in a similar manner as described above. For example, the second display 325 may also function as an input device (e.g., when the second display 325 is a touchscreen). In some embodiments, the second network interface 315 includes one or more transceivers for wirelessly communicating with the robotic tool 105 (e.g., a second RF transceiver configured to communicate via Bluetooth™, WiFi™, or the like). The second network interface 315 may include an additional transceiver for wirelessly communicating with the server 152 via, for example, cellular communication. The second network interface 315 may also include a second GPS receiver configured to receive a location signal from one or more satellites. In some embodiments, at least some of the transceivers and/or receivers of the external device 115 may be combined or share some elements (e.g., an antenna and/or other hardware). In some embodiments, the second electronic processor 305 sends data to and receives data from the robotic tool 105 and/or other devices of the communication system 100 via the second network interface 315.

The external device 115 may be, for example, a smart phone (as illustrated), a laptop computer, a tablet computer, a personal digital assistant (PDA), a wireless communication router that allows another external device 115 that is located remotely from the robotic tool 105 to communicate with the robotic tool 105, or another electronic device capable of communicating with the robotic tool 105. The external device 115 may generate a user interface on a display (described below) and allows a user to access and interact with robotic mower information in real time. The external device 115 may receive user inputs to determine operational parameters/instructions for the robotic tool 105, enable or disable features of the robotic tool 105, and the like. In some embodiments, the communication between the external device 115 and the robotic tool 105 may be wired (e.g., via a Universal Serial Bus (USB) cord configured to connect to respective USB ports of the external device 115 and the robotic tool 105). Broadly speaking, the user can interact with the external device 115 to control operation and/or future operation of the robotic tool 105.

In some embodiments, the external device 115 includes fewer or additional components in configurations different from that illustrated in FIG. 3. For example, the external device 115 may include a battery, a GPS receiver, or the like. In some embodiments, the external device 115 performs functionality other than the functionality described below.

In some embodiments, the server 152 includes similar elements as at least some of the elements described above with respect to the devices 105, 115 that function in a similar manner. For example, the server 152 may include an electronic processor, a memory, and a network interface, among other elements.

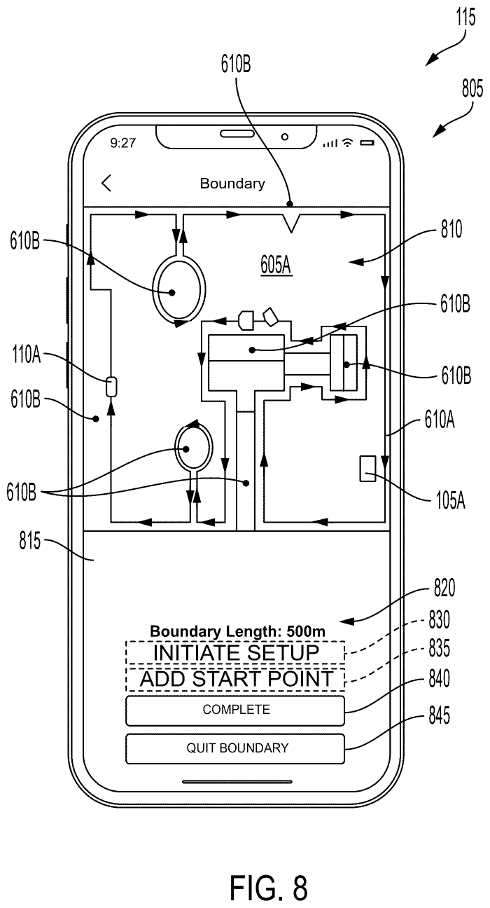

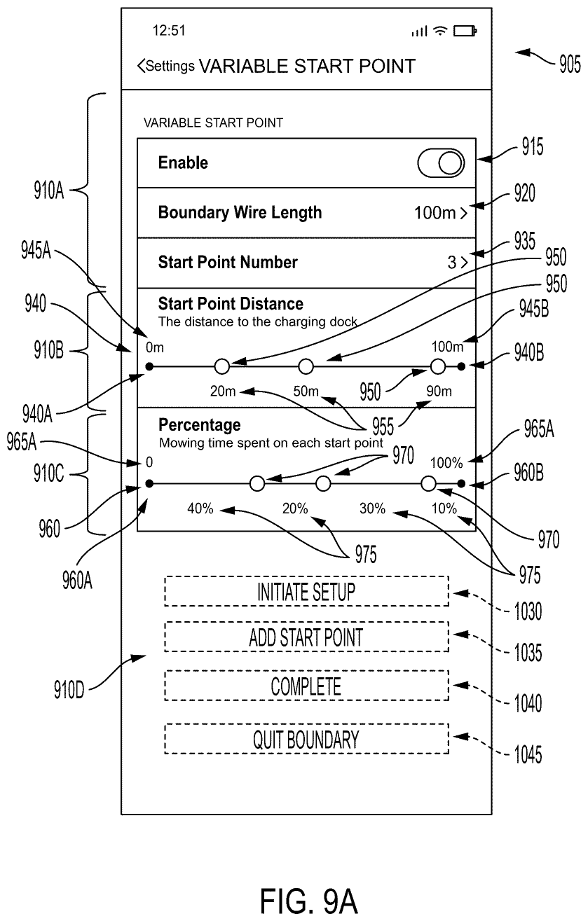

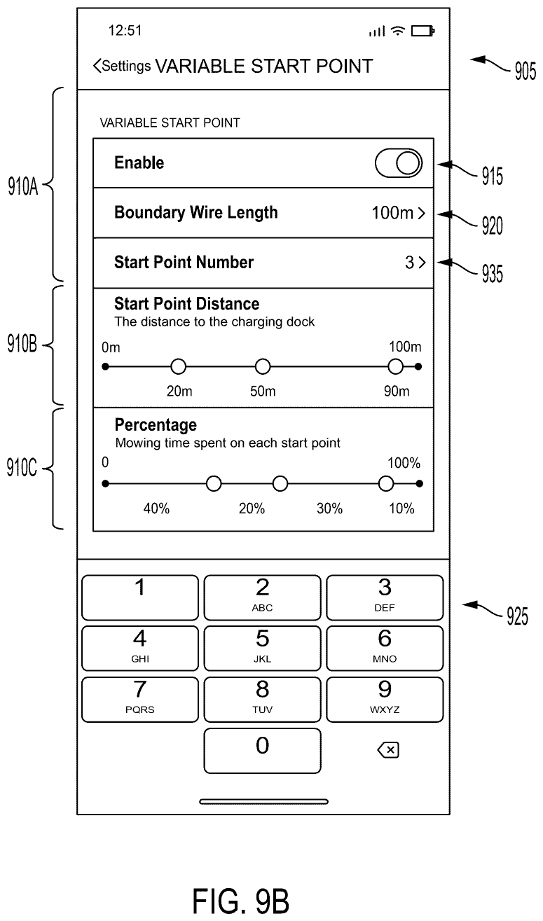

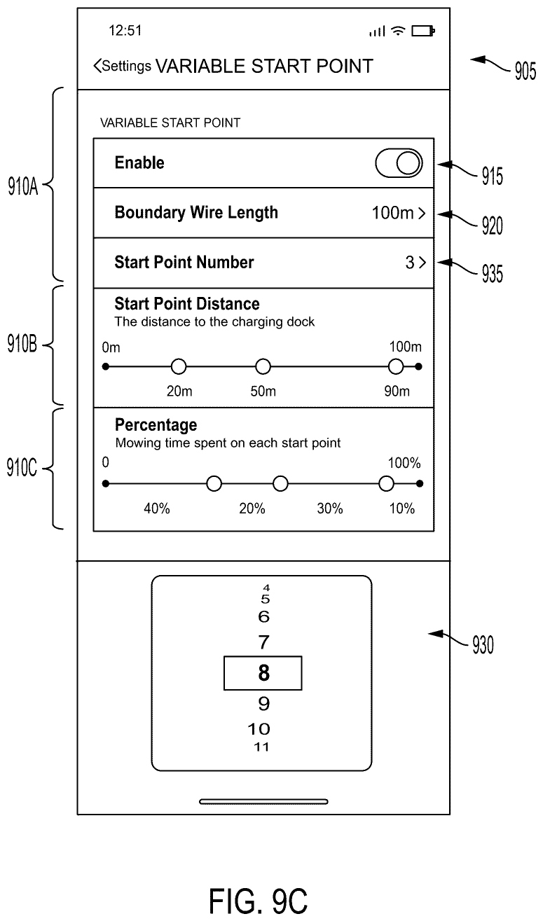

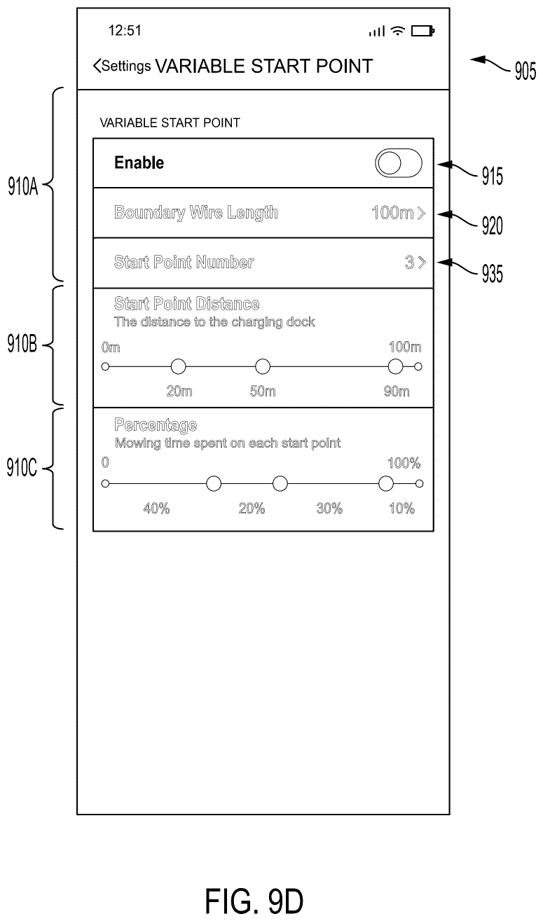

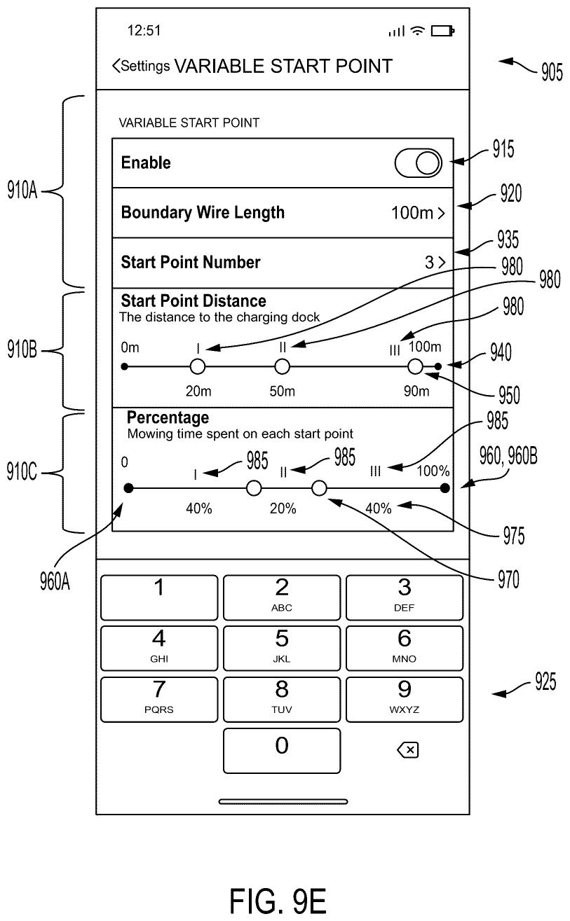

FIG. 8 illustrates one exemplary embodiment of a boundary screen 805 to be displayed on the second display 325 of the external device 115. The boundary screen 805 includes a map portion 810 and an interaction-display portion 815. The map portion 810 of the boundary screen 805 may be configured to overlay a series of indicia and/or other indicators onto a map of the operation area 605 to provide the user a visual representation of the current operational status of the system 100. In other embodiments, the boundary screen 805 may illustrate a generic map portion 810 which does not exactly replicate the operation area 605. In other words, the boundary screen 805 may not replicate the landscape of the operation area 605 as calculated by the odometry unit 250 but rather may include some pre-determined boundary outline (e.g., a generic house with driveway surrounded by a polygonal boundary). In some embodiments, a two-dimensional map of the operation area 605 may be provided, such as the map portion 810 illustrated in FIG. 8. This map portion 810 may or may not be representative of the actual dimensions of the operation area 605 and/or the boundary 610. In other embodiments, a one-dimensional line segment (e.g., the line segments 940, 960, described below with regard to FIG. 9A) may represent the perimeter 610. In some embodiments, the underlying map may include, but is not limited to, a user generated image of the desired region, a satellite image of the desired region, a computer-generated image of the desired area, and the like. More specifically, the illustrated map portion 810 includes a dock indicator 110A configured to represent the relative location of the docking station 110 within the operation area 605, a mower indicator 105A configured to represent the relative location of the robotic tool 105 within the operation area 605, an operating area map 605A configured to depict the general layout and shape of the operating area 605, and a perimeter indicator 610A configured to display the location of the perimeter 620 (e.g., the boundary wire 608) with respect to the operating area 605.

With continued reference to FIG. 8, obstacle indicators 610B may be provided on the map portion 810. As shown in FIG. 8, the obstacle indicators 610B may be, for example, sized to approximate the corresponding size of the obstacle it is configured to represent (e.g., the outer size and shape thereof) within the operating area 605. The obstacle indicators 610B may be positioned and/or sized to represent, for example, a building, tree, driveway, planter, garden, and other non-operating areas of the robotic tool 105 (e.g., non-mowable obstacles). As illustrated in FIG. 8, the perimeter indicator 610A may envelope but not pass through the obstacle indicators 610B. This represents actual operation of the robotic tool 105 avoiding the corresponding obstacle (building, tree, driveway, other non-operating area) during use. The obstacle indicators 610B may be adjustable in color and/or shape to correspond to the type of obstacle that they represent (e.g., a driveway may be colored grey, a tree may be colored a shade of green different than another shade of green of the operating area map 605A which represents the operating area 605, etc.). In some embodiments, the boundary screen 805 may update (e.g., automatically, contiguously, intermittently, etc.) the position of the mower indicator 105A with the sensed position (via the odometry unit 250) of the robotic tool 105 in the operating area 605. In other embodiments, the boundary screen 805 may not update the position of the mower indicator 105A with the sensed position of the robotic tool 105.

In some embodiments, the boundary screen 805 may be an accurate scaled representation of the size and shape of the operating area 605 and perimeter 610 with each indicator located in its real-time position. However, in other embodiments the boundary screen 805 may simply be display a generic representation of an operating area 605 and perimeter 610 with the indicators positioned in general positions. In some embodiments, the user may be able to zoom in, zoom out, and/or select the various indicia being displayed.

The interaction-display portion 815 of the boundary screen 805 may include a series of buttons and/or indicators through which the user may interact with the system 100 during use. In the illustrated embodiment, the interaction-display portion 815 includes a boundary length indicator 820, an “initiate setup” button 830, an “add start point” button 835, a “complete” button 840, and a “quit boundary” button 845. In other embodiments more or fewer buttons and/or indicators may be present. In other embodiments, the text on the buttons 830-845 may differ from the illustrated text. For example, the “add start point” button 835 may be a “modify start point” button 835.

The “initiate setup” button 830 is configured to instruct the system 100 (e.g., the external device 115 and tool 105) to initiate a setup sequence (described below). The “add start point” button 835 (and/or “modify start point” button) is configured to command the system 100 to add (and/or modify) a start point 615 to the existing list of start points. For example, in some embodiments selecting the “add start point” button 835 may cause the system 100 to communicate (e.g., retrieve), via the odometry unit 250, data relating to the position of the robotic tool 105, and to add a start point 615 at the current location of the tool 105 relative to the perimeter 620. However, in other embodiments selecting the “add start point” button 835 may cause a start point 615 to be added to a pre-determined position along the perimeter 810 whereby the user can later adjust the location of the start point 615 to the desired position.

Once added, the button 835 may transition to the “modify start point button” while the robotic tool 105 is adjacent the corresponding start point 615. When the “modify start point” button 835 is depressed, the user may be prompted to input a desired adjustment (e.g., +/−0.1 meter along the perimeter 610) and/or revised position (e.g., as a percentage of overall length and/or a desired position (e.g., 10 meters] relative to the docking station 110) for the start point 615. Once the robotic tool 105 moves away from the start point 615, the button 835 may transition back to the “add start point button” automatically. Additionally or alternatively, the “modify start point” button 835 may permit the user to delete any given start point. The “complete” button 840 may be configured to save the positions of any start points 615 present at that time. The “complete” button 840 may also be configured to end or conclude the initialization process (described below). Finally, the “quit boundary” button 845 is configured to exit or otherwise close the program.

In the illustrated boundary screen 805, the interaction-display portion 815 is positioned below the map portion 810. This may be reversed. Additionally, the various indicators and buttons 820-845 within the interaction-display portion 815 may be rearranged to any desired configuration relative to one another.

FIGS. 9A-9D illustrate screenshots of example screens/graphical user interfaces that may be displayed on the second display 325 of the external device 115. FIGS. 9A-9D illustrate the start point screen 905 in different situations that are explained below. In some embodiments, the start point screen 905 includes information related to the overall length of the perimeter 610, and the position of the start points 615A-615C with respect to the perimeter 610. As indicated previously herein, at least some of the information related to the robotic tool 105 that is displayed on the start point screen 905 may be wirelessly received by the external device 115 from the robotic tool 105.

As shown in FIG. 9A, the start point screen 905 includes a plurality of display areas 910A-910D. A first display area 910A thereof includes a slider or toggle 915 configured to enable and/or disable the variable start point feature of the robotic tool 105. When the slider 915 is in the enabled position (see FIG. 9A) the display areas 910A-910D are enabled and free to be manipulated by the user (e.g., via the touch screen of the external device 115). The system is also configured such that the tool 105 will operate using the variable start point capability as prescribed by the display areas 910A-910D (described below).

In contrast, when the slider 915 in the disabled position (see FIG. 9D), the interaction portions 910A-910D may be disabled and no longer accessible by the user. As shown in FIG. 9D, the start point screen 905 visually represents a disabled slider 915 by displaying the interaction portions 910A-910D in light grey tones. In other embodiments, the start point screen 905 may go blank or remove the relevant information when the slider 915 is disabled. Accordingly, the system 100 is configured such that the robotic tool 105 will not start from any set points saved on the first memory 210, the second memory 310, the memory of the server 152, or the memory of the docking station 110 when the variable start point slide 915 is in the disabled position. When the variable start point slide 915 is in the disabled position, in some embodiments, the robotic tool 105 may simply begin operation from the docking station 110. Similarly, when no start points 615A-615C have been generated (e.g., saved), the robotic tool 105 may simply begin operation from the docking station 110.

The first display area 910A of the start point screen 905 further includes an indicator 920 which displays the overall linear length of the perimeter 610. More specifically, the indicator 920 includes text indicative of the length of the perimeter 610 (e.g., “100 m”, “100 meters”, or the like). In the illustrated embodiment, an arrow or other indicia positioned adjacent to the indicator 920 signals to the user that the length of the perimeter 610 may be adjusted by interacting (e.g., tapping, clicking) with the indicator 920 via the second input device 320 (e.g., a touch screen, mouse, etc.). Upon interacting with the indicator 920, a keypad 925 (FIG. 9B) and/or a rotary selector 930 (FIG. 9C) may populate on the start point screen 905. The keypad 925 and the rotary selector 930 may each present a plurality of options for the user to adjust characteristics of the system 100. Other types of graphical user interfaces for gathering user input(s) may be displayed on the start point screen 905, such as but not limited to drop down menus, a plurality of checkboxes, radio buttons, toggle switches, and the like.

The user may interact with the second input device 320 (e.g., the touch screen, mouse) to input a known length of the perimeter 610 via the keypad 925 or the rotary selector 930. In some embodiments, a boundary length may be calculated automatically as part of the initial setup state (described below). The second input device 320 may be used in conjunction with the indicator 920 to adjust the length of the perimeter 610 after having been calculated by the odometry unit 250.

If the boundary length input by the user via the second input device 320 and in conjunction with the indicator 920 is different than the calculated perimeter length of the odometry unit 250, the user may be prompted by the device to confirm that the perimeter length should be adjusted and/or be prompted to return the robotic tool 105 to the docking station 110 to run the initial setup state again (described above). More specifically, if the perimeter length input by the user via the second input device 320 is less than the calculated boundary length of the odometry unit 250, the boundary length may be updated to the boundary length input by the user via the second input device 320. If any start points 615 must be removed to accommodate the newly entered boundary length (e.g., are positioned outside the newly established range), the user may be informed of which start point 615 may be deleted by the shortening of the boundary length. The user may then either select that the effected start point 615 can be deleted and/or to locate the start point 615 at the extreme end of the perimeter 610 (e.g., at the docking station 110). The user can then adjust the position of the effected start point 615 by moving the start point indicator 950 towards the first end 940A a desired amount such that the start point 615C is positioned on the perimeter 610 and not coincident with the docking station 110.

Once the perimeter length is input via the second input device 320, the perimeter length may be saved in the first memory 210, the second memory 310, the server 152, and/or the docking station 110. Any existing perimeter length data may be overwritten as needed. The updated perimeter length may then be displayed on the start point screen 905 via the indicator 920.

The first display area 910A further includes a start point number indicator 935 indicative of a total number of start points 615 on the perimeter 610. In the illustrated embodiment, the start point number indicator 935 may include text indicative of the number of start points 615 currently saved in memory (e.g., “3”, or the like). An arrow or other indicia may be positioned adjacent to the start point number indicator 935 to indicate to the user that the total number of start points 615 may be adjusted by interacting (e.g., tapping, clicking) with the start point number indicator 935 via the second input device 320 (e.g., a touch screen, mouse). In some embodiments, the user may interact with the second input device 320 (e.g., the touch screen, mouse) to input a desired number of start points 615 via the keypad 925 or the rotary selector 930. In such embodiments, any configuration of start points 615 may be suitable. For example, when the boundary wire length is 100 meters, and three start points 615A-C are selected, the default setting may be to space each start point 615A-C evenly over the entire length of the perimeter docking station 110 (e.g., at 25 m, 50 m, and 75 m from the docking station 110). In other embodiments, the start points may be spaced randomly over the perimeter length. In still other embodiments, the start point number indicator 935 may be automatically populated during the setup and initialization processes (described below).

By interacting (e.g., tapping, clicking) with the start point number indicator 935 via the second input device 320 (e.g., a touch screen, mouse), the total number of start points 615 may be increased or decreased according to a user's desired number of start points 615A-615C. When the total number of start points 615 is increased, the user may be prompted to add the additional start points 615 to a desired position along the perimeter 610. In other embodiments, the additional start point 615 may be added to a pre-determined default location along the perimeter 610 (e.g., at the docking station 110, halfway along the perimeter 610, at another position along the boundary, and the like). In other embodiments, the additional start point may be positioned at a preset position relative to other existing start points (e.g., halfway between a start point and either another start point and the dock). In the case that the total number of start points 615 is decreased, the user may be prompted to select one or more start points 615 to be removed/deleted. The remaining start points can be validated and/or adjusted as the user sees fit.

The second display area 910B relates to the position of the start points 625A-C of the robotic tool 105 with respect to their position along the length of the perimeter 610. More specifically, the second display area 910B provides a more visual representation of the location of the start points 615A-C along the length of the perimeter 610. In the illustrated embodiment, the second display area 910B includes a line segment 940 having a first end 940A, an opposite second end 940B, a first end indicia 945A positioned adjacent the first end 940A, and a second indica 945B positioned adjacent the second end 940B. In other embodiments, the line segment 940 may otherwise represent the perimeter 610 in another form. For example, the line segment 940 may be replaced by an enclosed box (e.g., rectangle), an open box (e.g., an open line segment), an actual map (e.g., the map portion 810), or the like.

The first end indicia 945A may indicate a relative position of the first end 945A of the line segment 940 relative to the docking station 110. Typically, the first end indicia 945A will display “0”, “0 m”, “0 meters”, or the like, as the docking station 110 may function as a home position of the tool 105. In contrast, the second end indicator 945B may indicate a current and/or full length of the perimeter 610. The second end indicator 945B typically will match the text of the indicator 920.

As shown in FIG. 9A, a plurality of start point indicators 950 are positioned along the line segment 940. In the illustrated embodiment, each start point indicator 950 includes a symbol or indicia (e.g., a circle) positioned on the line segment 940 in a position generally corresponding to the position of the represented start point 615A-C. While the illustrated indicators are circular, other types of start point indicators 950 may also be used (e.g., arrow, star, polygonal, or otherwise shaped). In some embodiments, each indicator 950 may include a label or have a unique shape to allow the user to more easily identify what start point 615A-C each indicator 950 represents (see label 984 of FIG. 9E). In the illustrated embodiment, the line segment 940 and the start point indicators 950 are differently colored to improve contrast. In other embodiments, the line segment 940 and the start point indicators 950 may be the same color. Furthermore, each start point indicator 950 is proportionally placed between the first end 940A and the second end 940B of the line segment 940 an amount corresponding to a length along the perimeter 610 between the docking station 110 and the corresponding start point 615A-C. For example, the length of the gap between the left-most start point indicator 950 and the first end 950A of the line segment 940 is 20% of the overall length of the line segment 940 (e.g., the distance between the first end 950A and the second end 950B) because the left-most start point indicator 950 is representative of the first start point 615A which, in turn, is positioned 20 meters from the docking station 110 where the overall length of the perimeter 610 is 100 meters. In other words, the start point indicator 950 provides accurate, to-scale visual representation of the position of each start point 615A-615C with respect to the overall length of the perimeter 610. In embodiments where one of the start points 615 are coincident with the docking station 110, the start point 615 may be represented by positioning the corresponding start point indicator 950 at one of the first end 940A and/or the second end 940B of the line segment 940.

In embodiments where the perimeter 610 is represented by a form other than the line (e.g., as an enclosed box, an open box, an actual map, etc.), the start point indicators 950 may be positioned adjacent to or along the other form in correspondence to the proportionality of the start points 615A-615C relative to the docking station 110.

With continued reference to FIG. 9A, a plurality of start point indicia or labels 955 are positioned below the line segment 940 and adjacent to a corresponding start point indicator 950. The illustrated start point indicia 955 include text (e.g., “20 m”, “50 m”, “90 m”) indicative of a length between the docking station 110 and the start point 615A-C being represented by that particular indicia 950.

As will be described in greater detail below, the second display area 910B is also configured to allow the user to independently adjust (i.e., edit) and/or modify the relative locations of each of the start point indicators 950, and as a result, the physical location of the start points 615A-615C along the length of the perimeter 610. More specifically, the user is able to independently adjust the relative location of any one of the start points 615A-615C by selecting and dragging the relevant indicator 950 to the desired location. For example, if the user wishes to move the first start point 615A so that it is 10 m from the home position, the user can select and drag the left-most indicator 950 toward the first end 940A until it is positioned at 10% of the overall length of the line segment 940 (e.g., at the 10 m position). In other embodiments, the user may independently modify the relative locations of each start point 615A-C by selecting the indicator 650 corresponding to the start point 615A-C the user wishes to move. Once selected, the display may provide a prompt to allow the user to enter the exact location (in meters, percentage, and the like) where the start point 615 should be located. The display will then automatically move the indicator 650 to represent the new location. In still other embodiments, both the “drag and drop” and “prompt” concepts may be used.

In embodiments where the perimeter 610 is represented by a form other than the line (e.g., as an enclosed box, an open box, an actual map, etc.), the start point indicators 950 may be adjusted in a similar manner (e.g., by dragging the start point indicator 950 along the actual map, etc., or by entering an exact location where the start point 615 should be located) to the start point indicators 950 positioned along the line segment 940.

The third display area 910C relates to the relative frequency at which each of the start points 615A-615C of the robotic tool 105 are utilized during operation. More specifically, the third display area 910C provides a graphical representation of the relative frequency at which the robotic tool 105 begins a session from each start point (discussed below). In the illustrated embodiment, the third display area 910C includes a line segment 960 having a first end 960A, and a second end 960B opposite the first end 960A. The first end indicia 965A is positioned adjacent the first end 960A and labels the beginning of the line segment 960. In the illustrated embodiment, the first end indicia 945A displays “0”. However, in other embodiments, the first end indicia 945A may display “0%” or the like. The second end indicator 945B is positioned adjacent the second end 960B and labels the end of the line segment 960. In the illustrated embodiment, the second end indicia 965B displays “100%”. However, in other embodiments, the second end indicia 965B may display “100” or the like.

As shown in FIG. 9A, the third display area 910C also includes a plurality of frequency adjustment indicators 970 positioned along the line segment 960 that, together, are configured to generally represent the frequency at which the tool 105 will begin a session from a particular start point 615A-615C. In other embodiments, the line segment 960 may otherwise represent an operating frequency of the robotic tool 105 at a desired start point 615A-615B. For example, the line segment 960 may be replaced by a pie chart, a doughnut chart, a tree map, a two-dimensional segmented column chart, and the like. More specifically, the third display area 910C is configured so that the size of the gap between the end indicia 960A, B and/or the indicators 970 themselves are scaled to represent the frequency each start point 615A-C is utilized. More specifically, the size of the left-most gap (e.g., between the first end indicia 960A the left-most indicator 970) generally corresponds to frequency at which the robotic tool 105 will depart from the first start point 615A positioned closest to the home position; the size of the left-center gap (e.g., between the left-most indicator 970 and the central indicator 970) generally corresponds to the frequency at which the tool 105 will depart from the second start point 615B positioned second closest to the home position; the size of the right-center gap (e.g., between the central indicator 970 and the right-most indicator 970) generally corresponds to the frequency at which the tool 105 will depart from the final start point 615C positioned furthest from the home position; and finally the right-most gap (e.g., between the right-most indicator 970 and the second end indicia 960B) generally corresponds to the frequency at which the tool 105 will depart directly from the docking station 110. In embodiments where the user does not want the docking station 110 to be considered a start point 615, the third display area 910C may include one less indicator 970 than the number of start points 615A-C so the number of gaps present matches the number of start points 615A-C(see FIG. 9E).

In embodiments where the line segment 960 is formed as a pie chart, the frequency indicators 970 may be represented as lines between adjacent pie segments. Other similar frequency indicators 970 are possible.

In the illustrated embodiment, the frequency adjustment indicators 970 are circularly shaped, and are positioned on the line segment 940. However, other types of frequency adjustment indicators 970 (e.g., arrow, star, polygonal, or otherwise shaped) may otherwise be positioned along, adjacent to, or otherwise indicating (e.g., via a color or shape thereof) a position along the line segment 960. In some embodiments, each indicator may include a label or have a unique shape to allow the user to more easily identify what start point 615A-C corresponds with each gap (see labels 985 of FIG. 9E). In the illustrated embodiment, the line segment 960 and the frequency adjustment indicators 970 are differently colored. In other embodiments, the line segment 960 and the frequency adjustment indicators 970 may be the same color.

With continued reference to FIG. 9A, a plurality of frequency indicia 975 are positioned below the line segment 940 and between two corresponding frequency adjustment indicators 970 and/or end indica 960A, 960B. In the illustrated embodiment, each of the plurality of frequency indicia 975 are centered between two adjacent corresponding frequency adjustment indicators 970. In the illustrated embodiment, the frequency indicia 975 include text (e.g., “40%”, “20%”, “30%”, 10%) indicative of a frequency with which the robotic tool 105 may begin mowing (e.g., begin a session) from a corresponding start point.

As will be described in greater detail below, the third display area 910C is also configured to allow the user to independently adjust and/or modify the frequency at which the tool 105 will depart any given start point 615A-C and/or the docking station 110. More specifically, the user is able to independently adjust the relative frequency for any one of the start points 615A-615C by selecting and dragging the relevant indicator 970 to the desired location. For example, if the user wishes to decrease the frequency of the first start point 615A, the user can select and drag the left-most indicator 970 toward the first end 960A until it is positioned closer thereto. By doing so, the user is decreasing the size of the left-most gap while also simultaneously increasing the size of the left-center gap. As such, each percentage point reduced from the first start point 615A will be added to the second start point 615B. As such, the third display area 910C automatically maintains the requisite 100% total frequency for all of the start points 615A-C and the docking station 110.

In embodiments where the line segment 960 is formed as a pie chart, the frequency indicators 970 adjusted between adjacent pie segments in manners similar to the above-described adjustment of the frequency indicators 970 (e.g., by dragging a line between adjacent pie segments, entering a desired start point frequency percentage). Other similar means to adjust the frequency indicators 970 are possible.

In another example, if the user would like to stop having the tool 105 depart directly from the docking station 110, the user can select and drag the right-most indicator 970 to the right until it is coincident with the second end 960B. By doing so, the right-most gap is eliminated setting the frequency value for the docking station 110 to 0%, at the same time, the user also increases the size of the right-center gap such that the third start point 615C will now have a frequency of 40% (see FIG. 9E).

The start point screen 905 further includes a fourth display area 910D. The fourth display area 910D includes a plurality of buttons and/or indicators for the user to interact with. More specifically, the fourth display area 910D includes an “initiate setup” button 1030, an “add start point” button 1035, a “complete” button 1040, and a “quit boundary” button 1045. These buttons are similar to the above-described buttons of the boundary screen 805 and therefore will not be described in detail herein. Additional or fewer user actuatable buttons may be provided on the start point screen 905.

In the illustrated embodiment, the first display area 910A, second display area 910B, the third display area 910C, and the fourth display area 910D are aligned with one another in a vertical direction (as viewed in FIG. 9A) on the second display 325. In other embodiments, only some of the display areas 910A-910D may be aligned with one another in the vertical direction of the second display 325. For example, the second display area 910B and the fourth display area 910D may be aligned in the vertical direction, while the third and fourth display areas 910A, 910D are otherwise positioned on the second display 325 or missing from the display 325. In the illustrated embodiment, the first display area 910A is at a top of the second display 325 as viewed in FIG. 9A, and the remaining display areas 910B-910D are provided below the first display area 910A in a sequential manner. The order of the display areas 910A-910D in the height direction may differ. Furthermore, the orientation and visual appearance of the individual line segments 940, 960 may also differ in other embodiments. For example, while the illustrated line segments 940, 960 are oriented horizontally, it is understood that in other embodiments different forms of visual user interface may be used such as, but not limited to, vertical line segments, vertical and/or horizontal bars, a number of user-manipulatable dials, text fields, and the like.

During operation, the robotic tool 105 may be in any one of a plurality of states at any given time. In some embodiments, the plurality of states include, but are not limited to an initial setup state, a modification state (i.e. to add, delete, or modify start point), a validation state, a combined initial setup and validation state (e.g., a combined state), a general operational state, a paused state, a perimeter cutting state, a perimeter walking state, a docking state, a charging state, a standby state, and an error state.

When operating in the initial setup state, the robotic mower 105 is configured to establish one or more start points 615 along the perimeter 610 of the operating area 605. To place the system 100 in the initial setup state, the user first actuates a button (e.g., the initiate setup button 830 on the boundary screen 805 or the initiate setup button 1030 on the start point screen 905) on the second input device 320 (e.g., the touch screen) of the external device 115.

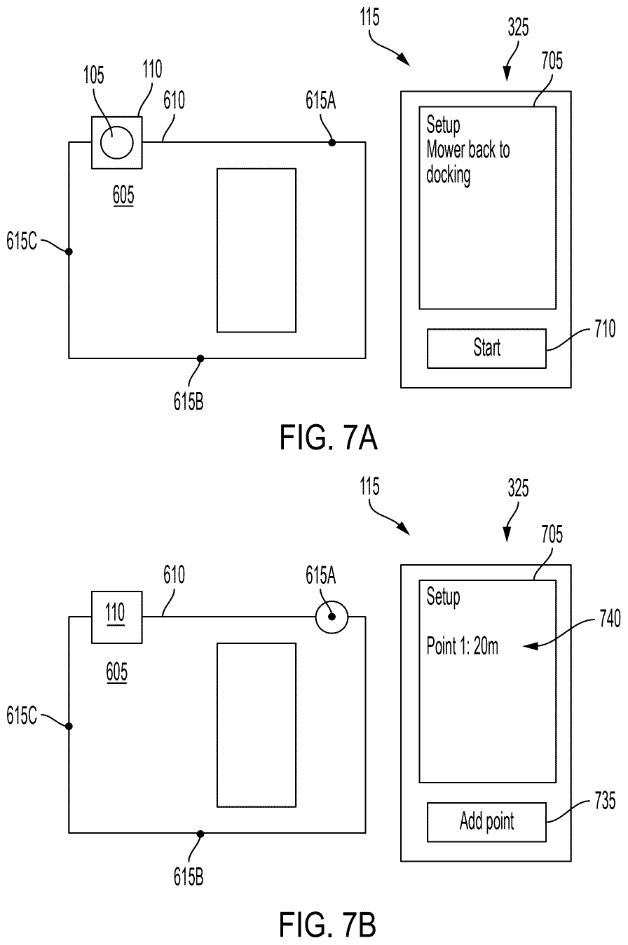

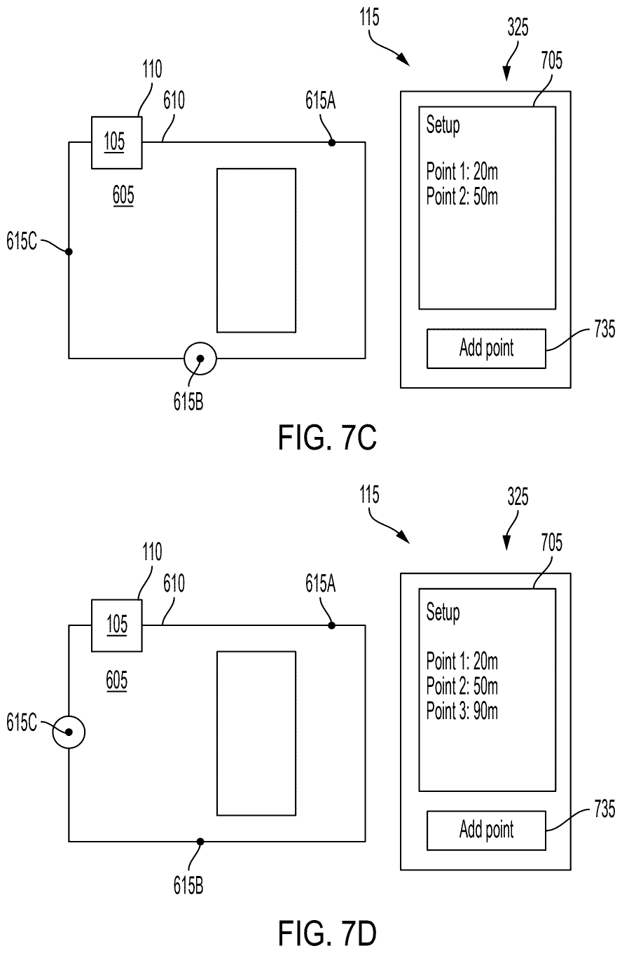

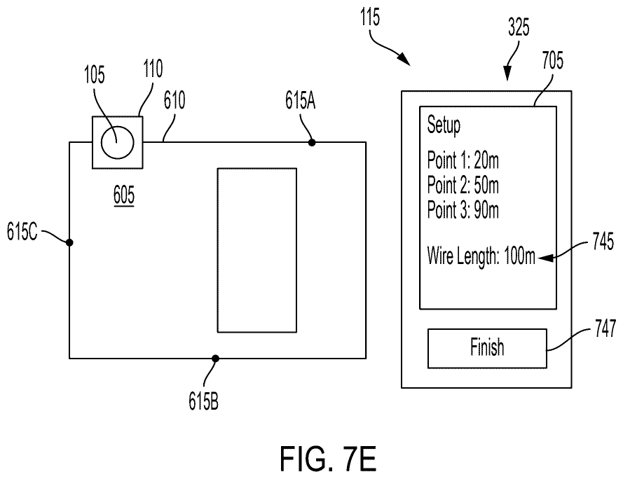

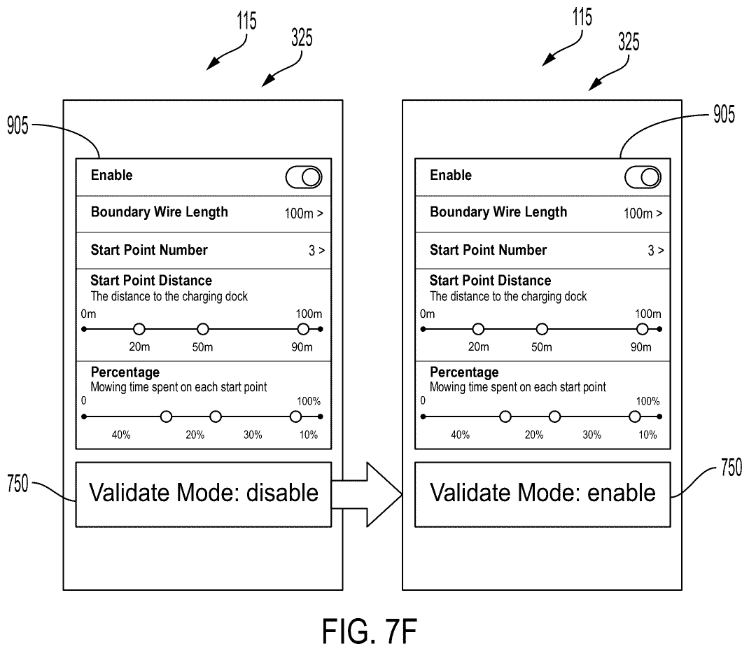

Once selected, a series of commands are executed in no particular order: 1) the external device 115 begins to display the initialization startup screen 705 on the second display 325 (see FIG. 7A), and 2) the external device 115 transmits, via the second network interface 315 of the external device 115, a command to the tool 105 to return to the docking station 110. In circumstances where the tool 105 is not already docked with the docking station 110, the tool 105 will begin to travel back toward the docking station 110 either directly and/or by traveling along the perimeter 610 (e.g., via the boundary wire 608). In some embodiments, the tool 105 may also output an audio and/or visual signal to indicate that it has entered the initial setup state. While the illustrated system 100 establishes the docking station 110 as a home position, it is understood that in systems 100 with more than one docking station or no docking station, other locations along the perimeter 610 may be used. In such embodiments, the tool 105 will travel to the home position when the initial startup state is selected.

After the tool 105 has returned to the docking station 110 and docked therewith (e.g., returned to the home position), the “start” button on the initialization startup screen 705 will become active on the external device 115 (see FIG. 7A). When the user is ready to begin the initialization process, the user may then select the start button 710 whereby the external device 115 will transmit a command to the tool 105, via the second network interface 315, to begin advancing along the perimeter 610 in a first direction (e.g., in a clockwise direction).

Upon receiving the command from the external device 115, the robotic tool 105 travels along the perimeter 610 in the first direction under its own control, relying on any one of the electromagnetic signals output by the boundary wire 608 and/or the odometry unit 250 for guidance and telemetry. In other embodiments, the robotic tool 105 could be moved along the perimeter 610 under manual control by the user (e.g., via remote control, and/or physical movement of the robotic tool 105 by the user). This would allow the user to define not only establish the perimeter 610 of the operating area 605, but further internal boundaries within the perimeter 610 for representing non-operating areas (e.g., buildings, trees, driveways, etc.). Furthermore, the odometry unit 250 of the robotic tool 105 is simultaneously measuring the current distance and/or trajectory of the robotic tool 105 has traveled along the perimeter 610 with respect to the home position (e.g., the docking station 110). For the purposes of this application the current linear distance between the tool 105 and the home position, as measured along the perimeter 610, is referred to as the “current travel distance.”

Once the tool 105 reaches the desired location along the perimeter 610 for the first start point 615A, the user selects the “add point” button 735 of the initialization startup screen 705 on the external device 115 (see FIG. 7B). By doing so, the external device 115 outputs a command to the tool 105 to record and output the current travel distance. Once the current travel distance is received by the external device 115, the device 115 displays an entry 740 on the second display 325 both confirming the start point 615A has been recorded and providing the details of the newly established start point 615A. In the illustrated embodiment, such details include listing the start point name or identification number (e.g., start point 615A is assigned the name “Point 1”), and displaying the linear distance between the start point 615A and the home position measured along the perimeter 610 (e.g., 20 m, see FIG. 7B). The odometry data indicative of the first start point 615A may then be stored by any of the first memory 210, the second memory 310, and/or the memory of the server 152. In some embodiments, the tool 105 may pause momentarily and/or output some form of audio and/or visual signal to confirm that the start point 615A has been created.

After the first start point 615A has been recorded and displayed, the tool 105 will resume traveling along the perimeter 610 in the first direction (e.g., in a clockwise direction) continuing to monitor and record the current travel distance and/or trajectory via the odometry unit 250. When the tool 105 reaches the desired location for the second start point 615B, the user again selects the “add point” button 735 of the display 795 on the external device 115. As discussed above, doing so causes the external device 115 to output a command to the tool 105 to record and output the current travel distance whereby the external device 115 will assign the point a name or identification number (e.g., start point 615B is assigned the name “Point 2”), and display the linear distance between the start point 615B and the home position (e.g., 50 m; see FIG. 7C). The user is then able to repeat this process until all of the desired start points 615A-C have been recorded and displayed in the manner discussed above (see FIG. 7D).

After completing a full loop of the perimeter 610 of the operating area 605, the tool 105 is configured to dock with the docking station 110 (when present) and record the overall perimeter distance and/or trajectory traveled via the odometry unit 250. The overall perimeter distance is then transmitted to the external device 115, via the first network interface 215. Once the final data is received, the external device 115 is configured to display the overall perimeter length 745 on the second display 325 and enable the “finish” button 747 (see FIG. 7E). In some other embodiments, the external device 115 is configured to display the map portion 810 representative of calculated dimensions of the perimeter 610. The user can then select the finish button 747 to exit the initial setup state and save all of the newly formed start points 615A-C and perimeter data in any one of the first memory 210, the second memory 310, and/or the memory of the server 152.

While the illustrated setup state created and recorded all of the desired start points 615A-C during a single loop of the perimeter 610, it is understood that in other embodiments the tool 105 may continue to loop the perimeter 610 (e.g., multiple times) until the user has created all of the desired start points 615A-C and selected the “finish” button 747. More specifically, the robotic tool 105 may take one or more laps around the perimeter 610 and relative to the docking station 110 in the initial setup state. None, one, or more than one start points 615A-615C may be saved during each lap around the perimeter 610 in the initial setup state. When calculating the boundary length, the robotic tool 105 may account for the number of laps around the perimeter 610 taken relative to the docking station 110. In some embodiments, the robotic tool 105 may take a first lap around the perimeter 610 and relative to the docking station 110. In this first lap, the odometry unit 250 may gather odometry data and calculate the boundary length. In a subsequent lap (i.e., a start point setting lap), the user may actuate the add start point button 1035 via the second input device 320 to set a start point (e.g., the start point 615A) along the perimeter 610. Any number of laps may be taken.

In still other embodiments, the screen 705 may include a button or feature allowing the user to individually select and delete specific start points 615 while remaining in the initial setup state. For example, if the user presses the “add point” button 735 at the wrong time (e.g., establishing a start point 615 in an undesired location) the screen 705 may have a button or feature whereby the offending start point 615 can be selected and deleted.

In some embodiments, the system 100 may include an alternative initial setup state whereby the user may use the external device 115 in place of the tool 105 to establish the start points 615A-C. Before the alternative initial setup state can be executed, the user may undergo some form of perimeter initialization. For example, in some embodiments a perimeter initialization may include having the tool 105 with an odometry unit 250 travel along and record the telemetry of the entire perimeter 610 of the operating area 605. In other embodiments, a perimeter initialization may occur when the user manually enters the layout and shape of the perimeter 610 into the device 115 (e.g., by entering the coordinates of waypoints and the like). In still other embodiments, the perimeter initialization may occur by having a computer-generated layout created based on one of a satellite image or other map of the operating area 605. In still other embodiments, a perimeter initialization may include the user having gone through the primary initial setup state discussed above.

With the perimeter initialized at some point in the past, the user may then enter the “alternative initial setup state” by selecting the necessary buttons on the second display 325 of the external device 115 (not shown). Once selected, the external device displays the initialization startup screen 705 or some variant thereof. The device 115 also activates and aligns the GPS or other location capabilities included thereon.

With the external device 115 prepared, the user can then walk directly to the location where he or she wishes the first start point 615A to be located. Once there, the user can select the “add point” button 735 whereby the GPS system of the device 115 records the present location of the device 115. Once recorded, the second electronic processor 305 is configured to compare and contrast the GPS data recorded by the device 115 with the initialized perimeter data discussed above. The second electronic processor 205 then enters the comparative data into one or more algorithms saved in the second memory 310 whereby the second electronic processor 305 establishes the first start point 615 at the point of the perimeter 610 located closest to the recorded GPS location. The algorithm then also calculates the current travel distance based on the initialized perimeter data. With the location and current travel distance established, the device 115 may then display the start point name and current travel distance on the second display 325 as discussed above. The user can then repeat this process until all of the desired start points 615A-C are created.

In still other embodiments, the user may walk along the perimeter 610 of the operating area 306 whereby the second electronic processor 305 will operate in a similar manner to that described with respect to the tool 105 above-only substituting the compiled GPS data from the device 115 for the odometry unit 250 data.

As shown in FIG. 7F, after at least one of the desired start points 615 is known (e.g., the first start point 615A has been recorded and saved), the system 100 may be placed in a “validation state” whereby the user is able to individually confirm that the start points 615A-C are each in a desired position and, if one or more of the start points 615 are misplaced, adjust the position of the start point 615 along the length of the perimeter 610.

To enter the validation state, the user may interact with the second input device 320 (e.g., the touch screen) of the external device 115. More specifically, when the user is viewing the start point screen 905, the user may actuate the “validate mode” icon 750-changing the icon 750 to the enabled condition and placing the system 100 in the validation state.

With the system 100 in the validation state, the user is then generally able to select any one of the start point indicators 950 whereby the system 100 will “validate” the start point position already stored in memory by instructing the tool 105 to physically travel to and stop at the saved position along the perimeter 610 of the operating area 605. If the indicated position is undesirable, the user may then manipulate the selected start point position (e.g., by sliding the corresponding start point indicator 950 along the line segment 940, described above), whereby the system 1000 will output instructions to the tool 105 so that any changes instituted by the user on the second display 325 of the external device 115 via the second input device 320 are physically carried out and reproduced in real-time along the perimeter 610 of the operating area 605 by the tool 105 itself.

Having enabled the validation state, the external device 115 begins by displaying start point screen 905 whereby each of the entries shown represents the current operating conditions of the system 100. More specifically, the second display area 910B includes a line segment 940 with a plurality of start point indicators 950 positioned thereon. The indicators 950, in turn, are positioned to represent the current saved start point 615 locations. For example, the left-most start point indicator 950 represents the saved location of the first start point 615A which is 20 meters from the home position, the middle start point indicator 950 represents the saved location of the second start point 615B which is 50 m from the home position, and the right-most indicator 950 represents the saved location of the third start point 615C which is 90 meters from the home position. The second display area 910B also includes a second end indicator 945B which displays the current saved overall perimeter length of the perimeter 610, which in the illustrated embodiment is 100 meters.

In addition to instructing the external device 115 to display the start point screen 905 as described above, the system 100 may also output instructions to the tool 105 instructing it to return to the home position (e.g., return to and dock with the docking station 110). In some embodiments, the tool 105 may output audio and/or visual signals indicating that it has entered into the validation state.

To validate one of the start point positions, the user must first select the indicator 950 corresponding to the desired start point 615A-C. For example, if the user wants to validate the first start point 615A, he or she may do so by selecting (e.g., taping on) the left-most start point indicator 950. Upon selecting the left-most start point indicator 950, the external device 115 is configured to output commands, via the second electronic processor 305, to the tool 105 instructing the tool 105 to travel along the perimeter 610 in the first direction (e.g., clockwise) for 20 meters. In some embodiments, the external device 115 may also display some form of acknowledgement (e.g., having the point indicator 950 change colors, begin blinking, change shape, and the like) to signal to the user that the command was received and in the process of being executed. In still other embodiments, the external device 115 may switch to an alternative screen layout emphasizing the current position of the first start point 615A and the options available to the user.

Upon receiving the command from the external device 115, the robotic tool 105 travels along the perimeter 610 in the first direction (e.g., clockwise) under its own control, relying on any one of the electromagnetic signals output by the boundary wire 608 and/or the odometry unit 250 for guidance and telemetry. Furthermore, the odometry unit 250 of the robotic tool 105 simultaneously measures the current distance the robotic tool 105 has traveled away from home position. Once the odometry unit 250 signals that 20 meters has been traversed, the robotic tool 105 comes to a stop. In some embodiments, the robotic tool 105 may also be configured to output a visual and/or audible signal to signify that the instructed location has been successfully reached.

In instances where the displayed start point location 615A is undesirable, the user may then adjust the position via the external device 115. More specifically, the user may select and drag the left-most point indicator 950 along the line segment 940 until the indicator 950 is in the desired location. For example, if the user believes the first start point 615A is too far from the docking station 110, the user may select and drag the left-most point indicator 950 to the left (e.g., toward the first end 940A) to the desired location (e.g., to a 10 m position).

Once the user disengages from the left-most point indicator 950, the updated location is saved in memory and the difference in position calculated by the second electronic processor 305. Once calculated, the external device 115 outputs a command to the tool 105 instructing it to travel 10 m closer to the home position (e.g., toward the docking station 110). Upon receiving the command from the external device 115, the robotic tool 105 travels along the perimeter 610 in a second direction (opposite the first direction) under its own control until the odometry unit 250 signals that 10 meters has been traversed. The tool 105 then comes to a stop at the updated location. The user is able to repeat the above described process until the first start point 615A is in the desired location. The first start point 615A may be repositioned to an adjusted (i.e., edited) first start point 615D. This adjusted first start point 615D may be saved to any viable memory (e.g., the first memory 210, the second memory 310, memory of the docking station 110, and/or memory of the server 152) for future recall.

With the first start point 615A in the desired position, the user may then validate another start point 615B, 615C by selecting another point indicator 950 as described above. Upon doing so, the external device 115 outputs commands to the tool 105 causing it to travel along the perimeter 610 until it is in a position corresponding to the saved position for the newly selected start point 615B, 615C. The user is then free to independently change the location of the selected start point 615B, 615C as described above.

Once all of the start points 615A-C have been validated, the user may then re-select the validation mode icon 750-changing the status to “disabled.” By doing so, the system 100 exits the validation state and any additional changes to the locations of the start points 615A-C will not be carried out by the tool 105.

In some embodiments, the system 100 may include a combined initial setup state and validation state (e.g., a combined state). In a combined state, the robotic tool 105 is configured to travel along the perimeter 610, receiving instructions from the external device 115 to add a start point 615A to the perimeter 610 at a particular location and to prompt the user to validate the start point before the tool 105 will continue along the perimeter 610 to the subsequent location. More specifically, the user first places the system 100 in the combined state by selecting one or more buttons on the external device 115 (not shown). Once selected, the external device 115 may be instructed to display the start point screen 905 while the tool 105 is instructed to return to the home position (e.g., to return to and dock with the docking station 110).

With the system 100 properly configured, the start point screen 905 may begin with the second display area 910B blank, only having a line segment 940 shown thereon. The user may then place an indicator 950 on the segment by tapping or touching the second input device 320, which may be a touchscreen including the second display 325, in the general location of where the user wishes the first start point 615A to be located. In some instances the screen 905 may include a keypad to allow the user to insert a specific value, however in other embodiments the user may drag his or her finger along the line segment 940 until the proper location is produced.

With the first indicator 950 positioned, the external device 115 may then save the position data in memory and output a command to the tool 105 to travel the selected distance along the perimeter 610. Upon receiving the command from the external device 115, the robotic tool 105 travels along the perimeter 610 in the first direction (e.g., clockwise) under its own control, relying on any one of the electromagnetic signals output by the boundary wire 608 and/or the odometry unit 250 for guidance and telemetry. Furthermore, the odometry unit 250 of the robotic tool 105 simultaneously measures the current distance the robotic tool 105 has traveled away from home position. Once the odometry unit 250 signals that the selected distance has been traversed, the robotic tool 105 comes to a stop. In some embodiments, the robotic tool 105 may also be configured to output a visual and/or audible signal to signify that the instructed location has been successfully reached.

With the tool 105 in position, the user may then evaluate whether the indicated position is acceptable. If the user does not accept the position, the user may then adjust the position as described above with respect to the validation state (e.g., the tool 105 will change positions along the perimeter 610 in real time to reflect the adjustments being made by the user). Once the position is acceptable, the user can accept the position (e.g., validate the position) whereby the tool 105 will begin traveling to the next desired position as established by the second placed indicator 950. In instances where no additional indicators 950 are present, the tool 105 may travel along the remainder of the perimeter 610 until it meets with and docks to the docking station 110—recording and saving the overall perimeter length at the same time.

Once all of the start points 615A-C are in the desired positions, the user may de-select the combined state whereby the system 100 will return to normal operating conditions.

In another embodiment of a combined state, a user may engage the initiate setup button 1030 of the second input device 320. By doing so, the tool 105 begins to travel along the perimeter 610 in the first direction (e.g., clockwise). Once the robotic tool 105 reaches a desired start point (e.g., start point 615A), the user can select the add start point button 1035 to instruct the robotic tool 105 to stop and gather data regarding the current position of the tool 105 as detected by the odometry unit 250. The collected data can then be saved as a first start point 615A, and displayed as a newly added start point indicator 950 positioned on the line segment 940.

Once the start point indicator 950 is added, the tool 105 remains in place allowing the user to evaluate whether the indicated position is acceptable. If the user does not accept the position, the user may then adjust the position as described above with respect to the validation state (e.g., the tool 105 will change positions along the perimeter 610 in real time to reflect the adjustments being made by the user). Once the position is acceptable, the user can accept the position (e.g., validate the position) whereby the tool 105 will continue traveling along the perimeter 610 in the first direction (e.g., clockwise).

After the first start point 615A is established, the user may continue to add subsequent start points 615B, 615C using the same process as described above. Once all of the start points 615A-C are established, the user may select (e.g., tap, click), via the second input device 320, the complete button 1040. The start points 615A-C and the position of the corresponding start point indicators 950 are then be saved in any of the first memory 210, the second memory 310, the memory of the docking station 110, or the memory of the server 152 for future reference. The system 100 can then return to normal operating conditions.

During operation in the general state, the robotic tool 105 is configured to carry out one or more operation sessions whereby the mower 105 travels within the perimeter 610 of an operating area 605 to execute a task (e.g., mowing a lawn, fertilizing a lawn, shoveling a driveway, and the like). More specifically, the tool 105 may be configured to travel randomly within the operating area 605 defined by the perimeter 610 with the goal of traveling over or engaging the entire operating area 605.

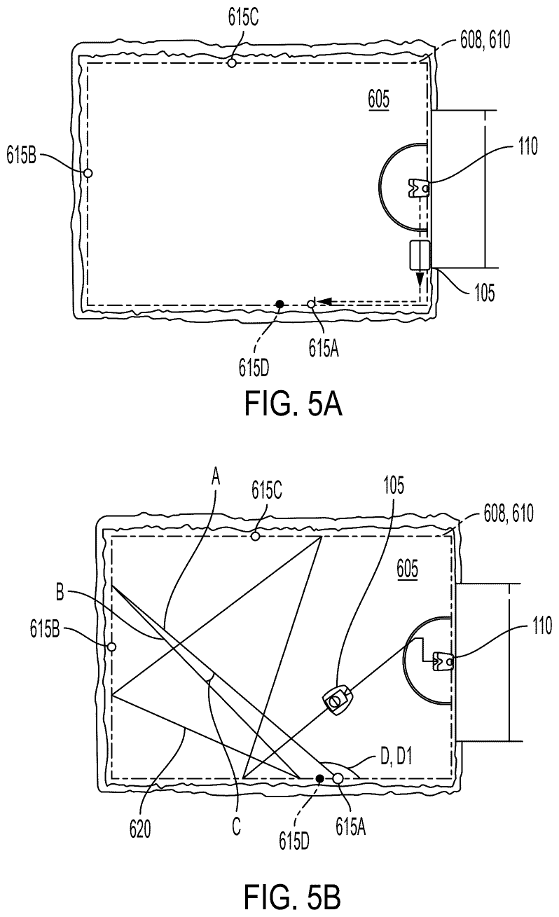

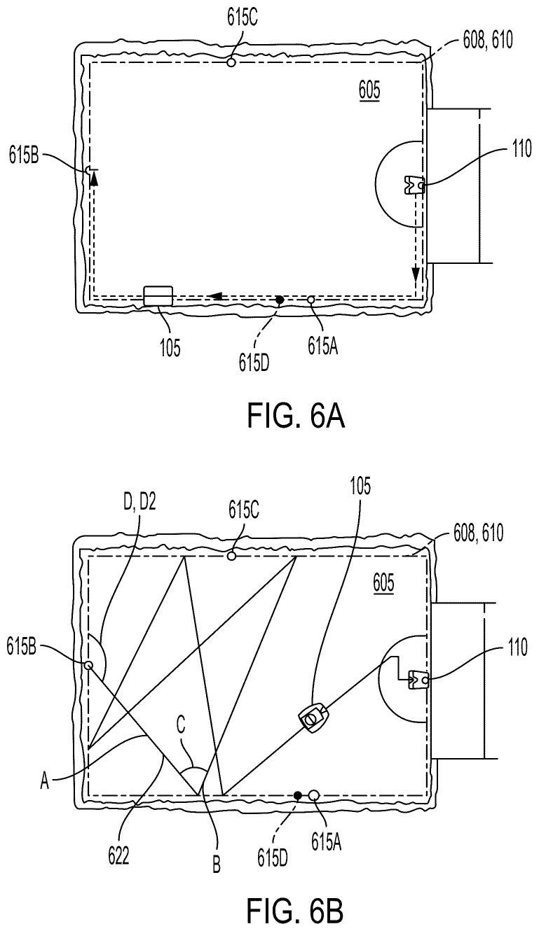

To do so, the tool 105 begins each session at a docking station 110 positioned on or near the perimeter 610 of the operating area 605 (e.g., a home position; see FIGS. 5, 6). As illustrated in FIG. 5, once prompted to begin operations in a general operational state, the robotic tool 105 first travels along the perimeter 610 (e.g., following the boundary wire 608 when present or traveling along a pre-saved perimeter path) until reaching the pre-selected one of a plurality of start points 615A-615C (described below). In some embodiments, the pre-selected start point 615A-C may be randomly generated or selected as part of an overall operating program. In other embodiments, the user may individually select an ordered list of start points 615A-C as they see fit.

As illustrated in FIG. 6, after reaching the desired start point (e.g., illustrated start point 615A in FIG. 6), the robotic tool 105 then turns and travels into the operating area 605 producing a first departure angle D1 relative to the perimeter 610. In some embodiments, the robotic tool 105 may also implement a first set of operating parameters (e.g., operating attributes) at this time. Such operational parameters may include, but are not limited to the cutting height, cutting speed, travel speed, etc.). Upon leaving the first start point 615A, the robotic tool 105 then travels in an approximate straight line across the operating area 605 defining a first path A and treating (e.g., cutting with the working tool 135) the vegetation over which it travels.

The tool 105 continues to travel along the first path A until the robotic tool 105 encounters and detects the perimeter 610. In the illustrated embodiment, the robotic tool 105 may detect the perimeter 610 based on the above-described electromagnetic signal emitted by the boundary wire 608. With the perimeter 610 detected, the robotic tool 105 is then configured to turn a predetermined amount (e.g., turn angle C) and continue traveling in an approximate straight line along a new, second path B while continuing to treat the operating area 605 over which the tool 105 passes. The mower 105 is then configured to travel along the new path B until encountering and detecting the perimeter 610, at which point the tool 105 undergoes a second turn and the process repeats.

The tool 105 is configured to continue operating in the above-described manner until the overall task completes (e.g., the entire operating area 605 has been treated) and/or some form of alert is detected (e.g., low battery) causing the session to end and the robotic tool 105 to return to the docking station 110.

Upon detecting and/or receiving an alert, the first electronic processor 205 of the robotic tool 105 may determine that the tool 105 should return to the docking station 110. For example, the first electronic processor 205 may indicate that an alert condition exists in response to determining that a charge level of the battery 245 is below a predetermined threshold, in response to determining that inclement weather is occurring or about to occur (e.g., based on detecting high humidity or rain by one or more of the sensors 230, etc.), or in response to determining that a scheduled time period for operation has elapsed or is about to elapse. In other embodiments, the robotic tool 105 may be configured to generate an alert and act upon the alert in response to detection of operating conditions relating to the environment within the operating area 605. For example, if vegetation within the operating area 605 is too rigorous (e.g., grass or vegetation too thick, too severely sloped terrain, icy driveways, etc.), operation of the robotic tool 105 my be adjusted and/or ceased. In some embodiments, the alert may be generated by the first electronic processor 205, and be transmitted via the first network interface 215 and the second network interface 315 to the external device 115 to be displayed to the user via the second display 325. The user may then choose to act upon the alert (e.g., ignore, return the robotic tool 105 to the docking station 110, and/or adjust an operational parameter of the tool 150 itself.

In instances where the robotic tool 105 is forced to return to the docking station 110 due to an alert (e.g., the previous session was ended), the robotic tool 105 may then begin a new session once the alert has been cleared (e.g., the battery has been charged, the fertilizer levels replenished, the error corrected, and/or obstruction cleared). To start the new session, the robotic tool 105 travels along the perimeter 610 until reaching a second start point 615B, different than the first start point 615A. The robotic tool 105 may be configured to start from one of a plurality of start points 615A-615C. As will be described in detail below, the robotic tool 105 may start at any one of the plurality of start points 615A-615C each time a new session begins.

As illustrated in FIG. 6B, once in place at the second start point 615B, the robotic tool 105 then turns and travels into the operating area 605 at a departure angle D2 while implementing a second set of operating parameters that may or may not be different from the first set of operating parameters. The robotic tool 105 then repeats the process as described above along a new set of travel paths 622 (including the above-described first path A, second path B). Depending on the size of the operating area 605 and the operating capabilities of the robotic tool 105 (e.g., an effective diameter of the cutting blades 140), the robotic tool 105 may undergo multiple sessions, each originating at a new start point, having a unique departure angle D, and/or unique operating parameters, until the task is complete.

Any parameter relating to the travel of the robotic tool 105 and/or the working tool 135 may be adjusted based on the start point 615A-615C at which the robotic tool 105 begins an operation session. For example, the robotic tool 105 may depart from any given start point 615A-615C at a preselected departure angle D which may be different than a departure angle of another start point (e.g., departure angle D1 from start point 615A and departure angle D2 from start point 615B may be different). In other embodiments, the robotic tool 105 may record, in memory (e.g., the first memory 210, the second memory 310, a memory of the docking station 110, or a memory of the server 152) a departure angle D1 of a first session of the robotic tool 105 starting at the first start point 615A. In a subsequent session of the robotic tool 105 starting at the first start point 615A, the departure angle D1 saved in the memory may be accessed by the first electronic processor 205, and the first electronic processor 205 may either choose to operate the robotic tool 105 with the same departure angle D1 as the first session, or another departure angle D1 different than the first session. In the event that the same departure angle D1 is used in the first session and the subsequent session, the robotic tool 105 may travel, in the subsequent session, along the same path 620 as the first session. In the event that differing departure angles D1 are used in the first session and the subsequent session, the robotic tool 105 may travel, in the subsequent session along a different path (not shown) when compared to the first session. In other embodiments, the path 620 may be generally random in the first session in which the robotic tool 105 starts at the start point 615A. The path 622 may travel in an entirely different manner than the path 620. For example, the path 622, starting from the start point 615B may travel in parallel rows or columns between sides of the perimeter 610.

In other embodiments, other operational parameters may be adjusted based on the start point 615A-615C at which the robotic tool 105 begins operation. For example, the different cutting height of the cutting blade 140 may be adjusted. The cutting blade 140 may be positioned at a first height (e.g., a high level) upon starting the session adjacent the first start point 615A. The sessions may be completed, and a subsequent session adjacent the second start point 615B may be initiated. Upon or prior to reaching the second start point 615B, the height of the cutting blade 140 may be positioned at a second height (e.g., a low level) for cutting vegetation. This may be especially helpful in areas (e.g., tall grass, wet grass) which are demanding on the cutting blade 104 and/or the working tool motor 240. In other embodiments, rather than adjusting a position (e.g., height) of the cutting blade (e.g., the working tool 135), the working tool motor 240 may be operated at different speeds. Various other attributes relating to adjusting operation of the travel and/or the operation of the working tool 135 based on a given start point 615A-615C are within the scope of the disclosure.

In the illustrated embodiment, the magnitude of the turn angle C, the magnitude of the departure angle D, and the order in which start points 615A-615C are selected is done at random (e.g., by a random number generator) by one of the first electronic processor 205 or the second electronic processor 305. By doing so, the robotic tool 105 travels along a unique path during each session. In other embodiments, a frequency of use of each of the start points 615A-615C may be monitored by, for example, the first processor 205, and the first processor 205 may instruct the robotic tool 105 to begin a session at a start point (e.g., the start point 615C) which has less than desired starts. For example, if a desired frequency at a start point (e.g., the start point 615C) is desired to be 30%, but the robotic tool 105 has only started 10% of sessions at the start point 615C, then the first processor 205 may choose to start the session with the robotic tool 105 at the start point 615C to balance the desired start point frequency and the actual frequency of which the robotic tool 105 starts at the start point 615C.

In other embodiments, the robotic tool 105 may travel in a fully or partially predetermined pattern within the operating area 605 perimeter 610. For example, the mower 105 may travel in parallel rows or columns between sides of the perimeter 610 to more efficiently and evenly cover the operating area 605. In still other embodiments, the robotic tool 105 may travel along pre-determined paths and/or keep track of its current location within the operating area 605. In embodiments where the previous travel path of the robotic tool 105 is recorded, the first electronic processor 205 and/or the second electronic processor 305 may be configured to review the path to assure that the entire operating area has been treated.

In still other embodiments, the robotic tool 105 may have a pre-ordered list of start points, departure angles D, and/or turn angles C for each subsequent session within a task. In such embodiments, the user may even select a particular program from a list of pre-determined path lists or path parameters to customize the task being performed by the robotic tool 105. Different portions of the operation area 605 may be prone to require differing amounts of operation thereon/therein. For example, in some instances, vegetation in some portions of the operation area 605 may be thicker, heavier, and/or grow at a rate higher than other portions of the operation area 605. In other instances, the operation area 605 itself may be shaped such that typical operation of the robotic tool 105 in the operation area 605 may force operation of the robotic tool 105 in some portions of the operation area 605 more than other portions of the operation area 605 (e.g., due to random turning or other turning sequences of the robotic tool 105 in the operation area 605). Accordingly, it may be difficult for a user to continuously monitor cutting operation of the lawn mower 105 for efficient operation of the robotic tool 105 in the operation area 605. Thus, there is a technological problem related to efficiently operating robotic garden tools in various portions of the operation area 605.

The systems, methods, and devices described herein address the above-noted technological problem by providing a user interface/screen on the second display 325 of the external device 115 to indicate various start point details of the robotic tool 105 to the user in an organized fashion. The user interfaces/screens also allow the user to easily revise/adjust start point information of the robotic tool 105. For example, a start point screen 905 (see FIGS. 9A-9D) provided on the second display 325 improves user interaction between the robotic tool 105 and the user to allow the user to monitor and adjust one or more start points of the robotic tool 105 (or of multiple robotic mowers 105) more efficiently. Further, operational parameters (e.g., relating to the path of the robotic tool 105 and/or the working tool 135) may be adjusted based on the start point (e.g., the first start point 615A) to further customize and thus improve efficiency of the robotic tool 105.

Although aspects of the disclosure have been described in detail with reference to certain preferred embodiments, variations and modifications exist within the scope and spirit of one or more independent aspects as described.

1. An external device for use with a robotic garden tool, the external device comprising:
a display;
a device network interface configured to allow the external device to wirelessly communicate with the robotic tool; and
an electronic processor coupled to the display, the device network interface, and a memory, and configured to communicate with the robotic garden tool via the device network interface, the electronic processor configured to
display a start point screen on the display, the start point screen including an initiate setup button and an add start point button,
wherein when the initiate setup button is selected by a first user input, the processor is configured to send a signal to the robotic garden tool to travel from a dock and along a perimeter of an operating area, and
wherein when the add start point button is selected by a second user input, the processor is configured to retrieve a first position of the robotic garden tool, the first position being indicative of a first start point remote of the dock.

2. The external device of claim 1, wherein the add start point button is configured to be selected during a first instance of the robotic garden tool traveling from the dock and along the boundary of the operating area.

3. The external device of claim 1, wherein the robotic garden tool includes a location tracking device which gathers data indicative of the position of the robotic garden tool, and wherein the location tracking device continuously communicates data indicative of the position of the robotic garden tool with the external device via the device network interface.

4. The external device of claim 3, wherein a current boundary length is calculated based on the data gathered by the location tracking device, and the current boundary length is displayed on the setup screen as the first robotic garden tool travels along the boundary.

5. The external device of claim 1, wherein the setup screen includes an indicia relating to a calculated perimeter length.

6. The external device of claim 1, wherein the setup screen includes a line segment indicative of the perimeter, and a first start point indicia is populated adjacent the line segment at a corresponding length along the boundary as the first position.

7. The external device of claim 6, wherein the setup screen further includes a start point indicia relating to the length of the first position relative to the dock.

8. The external device of claim 1, wherein in a first lap of the first robotic garden tool along the perimeter, the electronic processor gathers data for calculation of a boundary length, and in a subsequent start point setting lap of the robotic garden tool along the perimeter, the start point button is selected by the second user input to generate the first start point.

9. The external device of claim 1, wherein after the robotic garden tool returns to the dock and receives instructions to operate in a general operational state, the robotic garden tool is configured to travel along the perimeter to the first start point and operate within the operating area starting from the first start point.

10. The external device of claim 9, wherein when the add start point button is selected by a third user input, the processor is configured to retrieve a second position of the robotic garden tool, the second position being indicative of a second start point remote of the dock, the second position being different than the first position.

11. A device for use with a robotic garden tool, the device comprising:
a user interface;
a device network interface configured to allow the device to wirelessly communicate with the robotic tool; and
an electronic processor coupled to a display, the device network interface, and a memory, and configured to communicate with the robotic garden tool via the device network interface, the electronic processor configured to
change into a validation state upon receiving a first user input,
display a first start point indicator representative of a corresponding first start point saved in memory, and
wherein when the first start point indicator is selected by a user when the electronic processor is in the validation state, the processor is configured to send a signal to the robotic garden tool to travel to and stop at the first start point.

12. The device of claim 11, wherein the first start point is positioned remote of a docking station.

13. The device of claim 11, wherein the user interface includes a line segment, and wherein the first start point indicator is populated adjacent the line segment.

14. The device of claim 13, wherein when the user moves the first start point indicator along the line segment while the electronic processor is in the validation state after the robotic garden tool has stopped at the first start point, the electronic processor is configured to send a signal to the robotic garden tool to travel along a perimeter of a working area.

15. The device of claim 14, wherein the robotic garden tool physically travels a distance and a direction along the perimeter corresponding to a distance and a direction the first start point indicator is moved along the line segment.

16. The device of claim 11, wherein the electronic processor is configured to
display a second start point indicator representative of a second start point saved in memory, and
wherein when the second start point indicator is selected by the user when the electronic processor is in the validation state, the processor is configured to send a signal to the robotic garden tool to travel to and stop at the second start point.

17. A method of operating a robotic garden tool in a working area and remote of a dock, the method comprising:
recording a first start point and a second start point in a setup state, at least one of the first start point and the second start point being remote of the dock;
actuating a drive mechanism to move the robotic garden tool to the first start point;
after reaching the first start point, operating the robotic garden tool using a first operational parameter to enter the working area;
actuating the drive mechanism to move the robotic garden tool to the second start point; and
after reaching the second start point, operating the robotic garden tool using a second operational parameter to enter the working area, wherein the second operational parameter is different than the first operational parameter.

18. The method of claim 17, wherein at least one of the first operational parameter and the second operational parameter is selected from the group consisting of departure angle, turn angle, cutting pattern, travel path, cutting height, cutting speed, and travel speed.

19. The method of claim 17, wherein at least one of the first operational parameter and the second operational parameter is selected at random.

20. The method of claim 17, wherein at least one of the first operational parameter and the second operational parameter may be changed.
